(19) United States
(12) Patent Application Publication
(10) Pub. No.: US 2023/0118162 A1
(43) Pub. Date: Apr. 20, 2023

(54) COMPOSITE ANTI-FOULING COATINGS AND ASSOCIATED SYSTEMS AND METHODS

(71) Applicants: Massachusetts Institute of Technology, Cambridge, MA (US); Singapore University of Technology and Design, Singapore (SG)

(72) Inventors: Michael Short, Cambridge, MA (US); Max Carlson, Cambridge, MA (US); Robert Simpson, Singapore (SG)

(73) Assignees: Massachusetts Institute of Technology, Cambridge, MA (US); Singapore University of Technology and Design, Singapore (SG)

(21) Appl. No.: 17/910,320

(22) PCT Filed: Mar. 9, 2021
(86) PCT No.: PCT/US2021/021587

§ 371 Date: Sep. 8, 2022

Related U.S. Application Data
(60) Provisional application No. 62/987,322, filed on Mar. 9, 2020.

(51) Int. Cl. C09D 5/16

(52) U.S. Cl. CPC C09D 5/1618

(57) ABSTRACT

Composite anti-fouling coatings and associated systems and methods are generally described. In some aspects, a system comprises a substrate, a composite coating disposed on at least a portion of the substrate, and a fluid comprising one or more foulants, where the composite coating is configured to be in physical contact with the fluid during use. The composite coating may comprise a first region comprising a first material and a second region comprising a second material that is different from the first material. According to some embodiments, a full- spectral Hamaker constant associated with the composite coating and the fluid (i.e., based on average optical properties of the first and second materials of the composite coating) is relatively low, and the van der Waals (vdW) force between the composite coating and the one or more foulants is, therefore, correspondingly low. Under some conditions (e.g., high temperature and/or high pressure conditions), intermolecular interactions between the composite coating and the one or more foulants may be dominated by the vdW force, and a relatively low vdW force may reduce the likelihood of the one or more foulants adhering to and/or otherwise being deposited on the composite coating. By selecting materials for the composite coating that result in a relatively low full- spectral Hamaker constant, fouling of the composite coating may thus be reduced or even eliminated. In some cases, two or more materials with optical properties (e.g., refractive indices, frequency-dependent dielectric response values) that, when averaged, are substantially similar to those of the fluid across a spectrum of frequencies or wavelengths may advantageously be associated with a relatively low full- spectral Hamaker constant.

### RELATED APPLICATION

This application claims priority under 35 U.S.C. §119(e) to U.S. Provisional Application No. 62/987,322, filed Mar. 9, 2020, and entitled “Composite Anti-Fouling Coatings and Associated Systems and Methods,” which is incorporated herein by reference in its entirety for all purposes.

### TECHNICAL FIELD

Composite anti-fouling coatings and associated systems and methods are generally described.

### BACKGROUND

Fouling, or the undesired deposition of foulants on surfaces, affects a wide range of systems, including nuclear reactors, geothermal reservoirs, oil refineries, and chemical plants. The occurrence of fouling in these systems can have a variety of negative effects, such as increased pressure drops across system components, reduced heat transfer efficiency, inhibited fluid flow, accelerated corrosion, and reduced lifetime. Efforts to mitigate these effects, for example by ultrasonic cleaning, manual removal of deposits, and/or replacement of fouled components, are often costly and inconvenient. Thus, through mitigation costs, increased fuel consumption, and reduced throughput (e.g., lost revenue), fouling can have a significant economic impact - for example, fouling in nuclear reactors is estimated to cost the nuclear industry $120-150 million a year.

Researchers have investigated a number of approaches to reducing fouling, such as scale inhibitors, brine acidifiers, steam cleaning, ultrasonic surface cleaning, surface smoothing (e.g., electropolishing), polyphenylenesulfide-based or epoxy resin coatings, ceramic oxide coatings, and PTFE (Teflon) coatings. However, these approaches often cannot be applied in extreme environments. For example, although Teflon has been shown to resist buildup of foulants under certain conditions, nuclear reactors and geothermal plants are often operated under conditions that are too harsh for Teflon (or other organic materials) to remain stable. Thus, improved approaches to reducing fouling are needed.

### SUMMARY

Composite anti-fouling coatings and associated systems and methods are generally described. The subject matter disclosed herein involves, in some cases, interrelated products, alternative solutions to a particular problem, and/or a plurality of different uses of one or more systems and/or articles.

In some aspects, an article is provided. In some embodiments, the article comprises a substrate. In some embodiments, the article comprises a composite coating disposed on at least a portion of the substrate. In certain embodiments, the composite coating comprises a first region comprising a first material and a second region comprising a second material. In certain embodiments, the composite coating is configured to be exposed to a fluid comprising one or more foulants during use.

In some aspects, an article is provided. In some embodiments, the article comprises a substrate. In some embodiments, the article comprises a composite coating disposed on at least a portion of the substrate. In certain embodiments, the composite coating comprises a first region comprising a first material and a second region comprising a second material. In certain embodiments, the first material is associated with a first set of optical properties over a range of wavelengths. In certain embodiments, the second material is associated with a second set of optical properties over the range of wavelengths. In some embodiments, the composite coating is configured to be exposed to a fluid comprising one or more foulants during use. In certain embodiments, the fluid is associated with a third set of optical properties over the range of wavelengths. In some embodiments, a mean percentage difference between the third set of optical properties and an average of the first set of optical properties and the second set of optical properties is about 20% or less.

In some aspects, a system is provided. In some embodiments, the system comprises an article. In certain embodiments, the article comprises a substrate. In certain embodiments, the article comprises a composite coating disposed on at least a portion of the substrate. In some instances, the composite coating comprises a first region comprising a first material and a second region comprising a second material. In some embodiments, the system comprises a fluid comprising one or more foulants. In certain embodiments, the fluid is in physical contact with the article.

In some aspects, a system is provided. In some embodiments, the system comprises an article. In certain embodiments, the article comprises a substrate. In certain embodiments, the article comprises a composite coating disposed on at least a portion of the substrate. In some instances, the composite coating comprises a first region comprising a first material and a second region comprising a second material. In some instances, the first material is associated with a first set of optical properties over a range of wavelengths. In some instances, the second material is associated with a second set of optical properties over the range of wavelengths. In some embodiments, the system comprises a fluid comprising one or more foulants. In certain embodiments, the fluid is in physical contact with the article. In certain embodiments, the fluid is associated with a third set of optical properties over the range of wavelengths. In some embodiments, a mean percentage difference between the third set of optical properties and an average of the first set of optical properties and the second set of optical properties is about 20% or less.

In some aspects, a method is provided. In some embodiments, the method comprises depositing a first material of a composite coating in a first region on a substrate. In some embodiments, the method comprises depositing a second material of the composite coating in a second region on the substrate. In some embodiments, the composite coating is configured to be exposed to a fluid comprising one or more foulants during use. In certain embodiments, the first material of the composite coating is associated with a first set of optical properties over a range of wavelengths, the second material of the composite coating is associated with a second set of optical properties over the range of wavelengths, and the fluid is associated with a third set of optical properties over the range of wavelengths. In certain embodiments, a mean percentage difference between the third set of optical properties and an average of the first set of optical properties and the second set of optical properties is about 20% or less.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A shows, according to some embodiments, a schematic top-down view of an exemplary composite coating comprising first regions and second regions arranged in a regular alternating pattern;

FIG. 1B shows, according to some embodiments, a schematic top-down view of an exemplary composite coating comprising first regions and a second region arranged in a regular pattern;

FIG. 1C shows, according to some embodiments, a schematic cross-sectional view of an exemplary composite coating comprising a first layer and a second layer;

FIG. 1D shows, according to some embodiments, a schematic cross-sectional view of an exemplary composite coating comprising particles of a first material dispersed in a second material;

FIG. 2A shows an exemplary plot of refractive index as a function of wavelength for water, according to some embodiments;

FIG. 2B shows an exemplary plot of refractive index as a function of wavelength for ITO, according to some embodiments;

FIG. 2C shows an exemplary plot of refractive index as a function of wavelength for TiC, according to some embodiments;

FIG. 3A shows, according to some embodiments, a schematic illustration of an exemplary article comprising a planar substrate and a coating disposed on a surface of the planar substrate;

FIG. 3B shows, according to some embodiments, a schematic illustration of an exemplary article comprising a cylindrical substrate and a coating disposed on an exterior surface of the cylindrical substrate;

FIG. 3C shows, according to some embodiments, a schematic illustration of an exemplary article comprising a cylindrical substrate and a coating disposed on an interior surface of the cylindrical substrate;

FIG. 4A shows a schematic illustration of an exemplary system comprising a planar substrate, a coating disposed on a surface of the planar substrate, and a fluid comprising foulant particles, according to some embodiments;

FIG. 4B shows a schematic illustration of an exemplary system comprising a cylindrical substrate, a coating disposed on an outer surface of the cylindrical substrate, and a fluid comprising foulant particles, according to some embodiments;

FIG. 4C shows a schematic illustration of an exemplary system comprising a cylindrical substrate, a coating disposed on an inner surface of the cylindrical substrate, and a fluid comprising foulant particles, according to some embodiments;

FIG. 5A shows, according to some embodiments, an atomic force microscopy (AFM) image (left) and a grazing incidence X-ray diffraction (GIXD) crystallographic characterization (right) of a Si coating;

FIG. 5B shows, according to some embodiments, an AFM image (left) and a GIXD crystallographic characterization (right) of an ITO coating;

FIG. 5C shows, according to some embodiments, an AFM image (left) and a GIXD crystallographic characterization (right) of an amorphous FTO coating;

FIG. 5D shows, according to some embodiments, an AFM image (left) and a GIXD crystallographic characterization (right) of a crystalline FTO coating;

FIG. 5E shows, according to some embodiments, an AFM image (left) and a GIXD crystallographic characterization (right) of an SiO₂ coating;

FIG. 5F shows, according to some embodiments, an AFM image (left) and a GIXD crystallographic characterization (right) of an Na₃AlF₆ coating;

FIG. 5G shows, according to some embodiments, an AFM image (left) and a GIXD crystallographic characterization (right) of a CaF₂ coating;

FIG. 6A shows AFM measurements of Si, ITO, ITO glass, FTO glass, crystalline FTO (FTO*), SiO₂, CaF₂, Na₃AlF₆, and amorphous FTO coatings and Ni, Ag, SiO₂, SS304, TiO₂, and ZnO foulants in a droplet of deonized water, according to some embodiments;

FIG. 6B shows AFM measurements of Na₃AlF₆, CaF₂, SiO₂, and amorphous FTO coatings and Ni, Ag, SiO₂, SS304, TiO₂, and ZnO foulants in a droplet of deionized water, according to some embodiments

FIG. 7 shows, according to some embodiments, an exemplary plot of DFT-calculated Hamaker constants and refractive indices of potentially multi-foulant-resistant materials using crystalline SiO₂ as a foulant;

FIG. 8 shows an exemplary plot of measured and calculated adhesive forces as functions of DFT-calculated visible refractive indices for potentially multi-foulant-resistant materials, according to some embodiments;

FIG. 9A shows an exemplary plot of a full spectral optical constant n as a function of wavelength (nm) for CaF₂, according to some embodiments;

FIG. 9B shows an exemplary plot of a full spectral optical constant n as a function of wavelength (nm) for Na₃AlF₆, according to some embodiments;

FIG. 9C shows an exemplary plot of a full spectral optical constant n as a function of wavelength (nm) for amorphous FTO, according to some embodiments;

FIG. 9D shows an exemplary plot of a full spectral optical constant n as a function of wavelength (nm) for ITO, according to some embodiments;

FIG. 9E shows an exemplary plot of a full spectral optical constant n as a function of wavelength (nm) for SiO₂, according to some embodiments;

FIG. 9F shows an exemplary plot of a full spectral optical constant n as a function of wavelength (nm) for Si, according to some embodiments;

FIG. 9G shows an exemplary plot of a full spectral optical constant n as a function of wavelength (nm) for crystalline FTO, according to some embodiments; and

FIG. 10 shows, according to some embodiments, a schematic diagram of the main loop and the auxiliary loop of the Internally Heated Test Flow Loop (IHTFP);

FIG. 11 shows a schematic diagram of the IHTFP main loop, according to some embodiments;

FIG. 12 shows, according to some embodiments, schematic illustrations of a flow loop sample ring having grooves;

FIG. 13 shows a schematic illustration of a cylindrical mask holder for use during deposition of a coating, according to some embodiments;

FIG. 14A shows, according to some embodiments, a plot of relative crud reduction following IHTFP testing for TiC, ZrN, TiN, ZrC, Al₂O₃, TiB₂, ZrO₂, TiO₂, and MgO coating materials;

FIG. 14B shows, according to some embodiments, a plot of adhesive force (nN) as measured by atomic force microscopy (AFM) using an NiFe₂O₄-coated probe for TiN, MgO, ZrO₂, Al₂O₃, TiC, TiB₂, ZrC, ZrN, and TiO₂ coating materials;

FIG. 14C shows, according to some embodiments, a plot of adhesive force (nN) as measured by AFM using an NiO-coated probe for TiN, MgO, TiC, ZrC, Al₂O₃, ZrO₂, TiO₂, ZrN, and TiB₂ coating materials;

FIG. 15 shows a bar graph showing fouling resistance parameter values following IHTFP testing for SiO₂, CaF₂, Na₃AlF₆, F-DLC, FTO, and 1-µm-thick and 100-nm-thick amorphous carbon coatings, according to some embodiments;

FIG. 16A shows, according to some embodiments, a schematic illustration of the MIT Reactor (MITR) flow loop and photographs of the MITR core;

FIG. 16B shows, according to some embodiments, a schematic diagram of the MITR flow loop;

FIG. 17A shows a photograph of the sample holder used in MITR testing for 10 × 10 mm samples, according to some embodiments;

FIG. 17B shows a photograph of the sample holder used in MITR testing for 25 × 25 mm samples, according to some embodiments;

FIG. 18 shows, according to some embodiments, exemplary Raman spectra for a TiC coating without (left) and with (right) lead shielding;

FIG. 19A shows Raman spectra for a CaF₂ coating following MITR flow loop testing, according to some embodiments;

FIG. 19B shows Raman spectra for a ZrN coating following MITR flow loop testing, according to some embodiments;

FIG. 19C shows Raman spectra for a TiC coating following MITR flow loop testing, according to some embodiments;

FIG. 19D shows Raman spectra for an F-DLC coating following MITR flow loop testing, according to some embodiments; and

FIG. 19E shows Raman spectra for irradiated and unirradiated F-DLC, unirradiated 1-µm-thick amorphous carbon, and unirradiated 100-nm-thick amorphous carbon coatings, according to some embodiments.

### DETAILED DESCRIPTION

Composite anti-fouling coatings and associated systems and methods are generally described. In some aspects, a system comprises a substrate, a composite coating disposed on at least a portion of the substrate, and a fluid comprising one or more foulants, where the composite coating is configured to be in physical contact with the fluid during use. The composite coating may comprise a first region comprising a first material and a second region comprising a second material that is different from the first material. According to some embodiments, a full-spectral Hamaker constant associated with the composite coating and the fluid (i.e., based on average optical properties of the first and second materials of the composite coating) is relatively low, and the van der Waals (vdW) force between the composite coating and the one or more foulants is, therefore, correspondingly low. Under some conditions (e.g., high temperature and/or high pressure conditions), intermolecular interactions between the composite coating and the one or more foulants may be dominated by the vdW force, and a relatively low vdW force may reduce the likelihood of the one or more foulants adhering to and/or otherwise being deposited on the composite coating. By selecting materials for the composite coating that result in a relatively low full-spectral Hamaker constant, fouling of the composite coating may thus be reduced or even eliminated. In some cases, two or more materials with optical properties (e.g., refractive indices, frequency-dependent dielectric response values) that, when averaged, are substantially similar to those of the fluid across a spectrum of frequencies or wavelengths may advantageously be associated with a relatively low full-spectral Hamaker constant.

Fouling generally refers to the unwanted accumulation of molecules, such as inorganic particles, microorganisms, macromolecules, and/or corrosion products, on a surface. Fouling may have a detrimental impact on a wide range of systems, including nuclear reactors, geothermal reservoirs, oil refineries, and chemical plants. For example, fouling can increase pressure drops across system components, reduce heat transfer efficiency, inhibit fluid flow, and/or accelerate corrosion. In nuclear power plants, inability to control fouling can result in less aggressive fuel loading patterns, longer outages, increased radiation exposure for workers, mandatory power deratings, and nuclear fuel failure by crud-induced localized corrosion. Efforts to mitigate these effects are often costly and/or inconvenient, and may be ineffective at high temperatures and/or pressures. Thus, there is a need for improved anti-fouling approaches, particularly for systems that are operated under high temperature and/or high pressure conditions.

Adhesion of foulant molecules to a surface may be governed by a number of forces, including vdW, magnetic, static charge, and steric bonding forces. Under some conditions, however, such as high temperature and/or high pressure conditions, interactions between foulant molecules and a surface at short-range distances (e.g., about 100 nm or less) may be dominated by vdW forces. Under such conditions, the contributions of other forces may be minimal or nonexistent and, therefore, may be excluded. The inventors have recognized and appreciated that, under such conditions, minimizing vdW forces between a foulant and a surface may reduce and/or prevent foulant adhesion to the surface.

A vdW force generally refers to an intermolecular force that arises from the formation and/or interaction of two or more induced dipoles. A vdW force F_{vdW} between a foulant particle (approximated as a sphere) and a surface (e.g., a coating surface approximated as a flat plane) may be calculated according to Equation 1:

$${F}_{v d W} = \frac{{A}_{H a m} R}{6 {l}^{2}}$$

where A_{Ham} is the Hamaker constant, R is the radius of the foulant particle, and l is the distance between the foulant particle and the surface.

The vdW force is directly proportional to Hamaker constant A_{Ham}, which largely defines the magnitude of the vdW force. Hamaker constant A_{Ham} may be defined as the sum of all induced-dipole forces between material a (i.e., a surface, such as a coating surface) and material b (i.e., a foulant particle) interacting through an intervening fluid f, as shown in Equation 2:

$${A}_{H a m} \approx \frac{3 {k}_{B} T}{2} {\sum }_{n = 0}^{∞} {Δ}_{a f} \left({ξ}_{n}\right) {Δ}_{f b} \left({ξ}_{n}\right) {R}_{n} \left(l , {ξ}_{n}\right)$$

where k_{B} is Boltzmann’s constant, T is the temperature in Kelvin, Rₙ is an optical retardation factor, Δᵢⱼ (ξₙ) is the difference in the dielectric response of two materials at an imaginary frequency ξₙ, and n is a discrete energy level from 0 to infinity. In particular, Δ_{af}(ξₙ) is the difference in the dielectric response of material a (i.e., a surface, such as a coating surface) and fluid f, and Δ_{fb} (ξₙ) is the difference in the dielectric response of fluid f and material b (i.e., a foulant particle). Each Δᵢⱼ(ξₙ) may be calculated according to Equation 3:

$${Δ}_{i j} \left({ξ}_{n}\right) = \frac{{∈}_{i} \left(i {ξ}_{n}\right) - {∈}_{j} \left(i {ξ}_{n}\right)}{{∈}_{i} \left(i {ξ}_{n}\right) + {∈}_{j} \left(i {ξ}_{n}\right)}$$

where ∈ⱼ(iξₙ) is the dielectric function of material j evaluated at imaginary frequency ξₙ. The dielectric response values ∈ⱼ(iξₙ) are evaluated at discrete frequencies ξₙ with:

$${ξ}_{n} = \frac{{k}_{B} T}{h} n$$

where h is Planck’s constant. A person of ordinary skill in the art would appreciate that frequency ξₙ is inversely related to wavelength λₙ (generally as

$${ξ}_{n} = \frac{1}{{λ}_{n}}$$

). A person of ordinary skill would also appreciate that dielectric response value ∈ⱼ is related to index of refraction (i.e., refractive index) nᵣ according to Equation 5:

$${∈}_{j} = {n}_{r j}^{2}$$

Each ∈ⱼ (iξₙ) can be expressed in terms of its real, measureable components by applying the Kramers-Kronig transform, which connects the real and imaginary components of a causal function, as shown in Equation 6:

$$∈ \left(i ξ\right) = 1 + \frac{2}{π} {\int }_{o}^{∞} \frac{ω ∈ " \left(ω\right)}{{ω}^{2} + {ξ}^{2}} d ω$$

where ω is a real frequency. Dielectric response values ∈(w) can be experimentally measured or obtained from tabulated optical data available in the literature. Thus, using Equations 1 to 6, dielectric response values ∈(w) may be used to determine a Hamaker constant A_{Ham}.

As shown in Equation 2, Rₙ(l,ξₙ) terms may optionally be included in determining a Hamaker constant A_{Ham}. The Rₙ(l,ξₙ) terms represent relativistic screening, or retardation, effects due to the finite time required for electromagnetic waves to travel through the fluid from the foulant particle to the coating surface (or vice versa). These relativistic terms are defined according to Equation 7:

$${R}_{n} \left(l , {ξ}_{n}\right) = \left(1 + {r}_{n}\right) {e}^{- {r}_{n}}$$

where:

$${r}_{n} = \frac{2 l {n}_{f} {ξ}_{n}}{c}$$

where n_{f} is the refractive index of the fluid at discrete frequency ξₙ and c is the speed of light. The contributions of the relativistic terms may increase as the distance between the foulant particle and the coating surface is increased. For example, when distance l = 1 nm, the vdW force is decreased 0-1% compared to the non-relativistic form (i.e., where Rₙ is assumed to be unity). In contrast, when distance l = 10 nm, there is a 10-20% reduction in vdW force compared to the non-relativistic form, and the relativistic contribution should not be dismissed.

In some embodiments, the Hamaker constant may be calculated and/or measured at approximately room temperature (e.g., about 20° C.). That is, in certain cases, the Hamaker constant may be calculated based on optical properties (e.g., indices of refraction, dielectric response values) calculated and/or measured at approximately room temperature (e.g., about 20° C.). While articles described herein may be used in systems operated at high temperatures, the inventors have demonstrated that a Hamaker constant calculated and/or measured at approximately room temperature may accurately predict vdW forces and fouling behavior at high temperatures. A Hamaker constant may also be calculated and/or measured at temperatures other than room temperature. In some embodiments, a Hamaker constant is calculated and/or measured at a temperature of at least 20° C., at least 25° C., at least 30° C., at least 40° C., at least 50° C., at least 60° C., at least 70° C., at least 80° C., at least 90° C., at least 100° C., at least 150° C., at least 200° C., at least 250° C., at least 300° C., at least 315° C., at least 330° C., at least 350° C., at least 400° C., or at least 500° C. In some embodiments, a Hamaker constant is calculated and/or measured at a temperature of about 500° C. or less, about 400° C. or less, about 350° C. or less, about 330° C. or less, about 315° C. or less, about 300° C. or less, about 250° C. or less, about 200° C. or less, about 150° C. or less, about 100° C. or less, about 90° C. or less, about 80° C. or less, about 70° C. or less, about 60° C. or less, about 50° C. or less, about 40° C. or less, about 30° C. or less, about 25° C. or less, or about 20° C. or less. In some embodiments, a Hamaker constant is calculated and/or measured at a temperature in a range from 20° C. to 25° C., 20° C. to 30° C., 20° C. to 50° C., 20° C. to 100° C., 20° C. to 150° C., 20° C. to 200° C., 20° C. to 300° C., 20° C. to 315° C., 20° C. to 330° C., 20° C. to 350° C., 20° C. to 400° C., 20° C. to 500° C., 25° C. to 30° C., 25° C. to 50° C., 25° C. to 100° C., 25° C. to 150° C., 25° C. to 200° C., 25° C. to 300° C., 25° C. to 315° C., 25° C. to 330° C., 25° C. to 350° C., 25° C. to 400° C., 25° C. to 500° C., 50° C. to 100° C., 50° C. to 150° C., 50° C. to 200° C., 50° C. to 300° C., 50° C. to 315° C., 50° C. to 330° C., 50° C. to 350° C., 50° C. to 400° C., 50° C. to 500° C., 100° C. to 150° C., 100° C. to 200° C., 100° C. to 300° C., 100° C. to 315° C., 100° C. to 330° C., 100° C. to 350° C., 100° C. to 400° C., 100° C. to 500° C., 200° C. to 300° C., 200° C. to 315° C., 200° C. to 330° C., 200° C. to 350° C., 200° C. to 400° C., 200° C. to 500° C., 300° C. to 315° C., 300° C. to 330° C., 300° C. to 350° C., 300° C. to 400° C., 300° C. to 500° C., or 400° C. to 500° C.

In some embodiments, the Hamaker constant is a full-spectral Hamaker constant. A full-spectral Hamaker constant refers to a Hamaker constant that is calculated and/or measured over the dielectric spectrum of two materials (e.g., a coating surface and a foulant particle) and an intervening fluid. In some embodiments, a full-spectral Hamaker constant is calculated and/or measured over wavelengths in a range from 10 nm to 100 nm, 10 nm to 300 nm, 10 nm to 400 nm, 10 nm to 500 nm, 10 nm to 700 nm, 10 nm to 1 µm, 10 nm to 2 µm, 10 nm to 3 µm, 10 nm to 4 µm, 10 nm to 5 µm, 100 nm to 300 nm, 100 nm to 400 nm, 100 nm to 500 nm, 100 nm to 700 nm, 100 nm to 1 µm, 100 nm to 2 µm, 100 nm to 3 µm, 100 nm to 4 µm, 100 nm to 5 µm, 190 nm to 400 nm, 190 nm to 500 nm, 190 nm to 700 nm, 190 nm to 1 µm, 190 nm to 2 µm, 190 nm to 3 µm, 190 nm to 4 µm, 190 nm to 5 µm, 300 nm to 400 nm, 300 nm to 500 nm, 300 nm to 700 nm, 300 nm to 1 µm, 300 nm to 2 µm, 300 nm to 3 µm, 300 nm to 4 µm, 300 nm to 5 µm, 400 nm to 500 nm, 400 nm to 700 nm, 400 nm to 1 µm, 400 nm to 2 µm, 400 nm to 3 µm, 400 nm to 4 µm, 400 nm to 5 µm, 500 nm to 700 nm, 500 nm to 1 µm, 500 nm to 2 µm, 500 nm to 3 µm, 500 nm to 4 µm, 500 nm to 5 µm, 700 nm to 1 µm, 700 nm to 2 µm, 700 nm to 3 µm, 700 nm to 4 µm, 700 nm to 5 µm, or 1 µm to 5 µm.

It had previously been thought that a Hamaker constant approximated using a single-frequency or single-oscillator model, such as the Tabor-Winterton Approximation (TWA), could be used to design a coating with anti-fouling properties. However, the inventors have recognized and appreciated that a full-spectral Hamaker constant - i.e., a Hamaker constant that is not based on an approximation at a single frequency - more accurately captures anti-fouling behavior.

In some embodiments, a full-spectral Hamaker constant for a system comprising a fluid comprising one or more foulants and a coating disposed on a substrate may be calculated using one or more computational methods (e.g., atomistic simulation methods). A non-limiting example of a suitable computational method is density functional theory (DFT). In some embodiments, computational methods can be used to compute frequency-dependent dielectric responses governing the interaction between foulant particles and a coating surface. In certain cases, the Hamaker constant can be approximated by the series expansion shown in Equation 9:

$${A}_{H a m} \approx \frac{3 {k}_{B} T}{2} {\sum }_{n = 0}^{1000} {\sum }_{s = 1}^{5} \frac{{\left({Δ}_{a f} \left({ξ}_{n}\right) {Δ}_{f b} \left({ξ}_{n}\right) R\right)}^{s}}{{s}^{3}}$$

where the Δ_{ab}(ξₙ) values are defined according to Equation 10:

$${Δ}_{a b} \left({ξ}_{n}\right) = \frac{{ε}_{a} \left(i {E}_{n}\right) - {ε}_{b} \left(i {E}_{n}\right)}{{ε}_{a} \left(i {E}_{n}\right) + {ε}_{b} \left(i {E}_{n}\right)}$$

The real-valued function of imaginary frequencies are evaluated at discrete values of energy, according to Equation 11:

$${E}_{n} ≡ n 2 π {k}_{B} T$$

where n ≥ 0. In certain embodiments, the Hamaker constant may be computed based on at least 100 values of n, at least 200 values of n, at least 500 values of n, at least 1000 values of n, or at least 2000 values of n. In certain instances, the Hamaker constant may be computed based on a number of n values in a range from 100 to 200 values, 100 to 500 values, 100 to 1000 values, 100 to 2000 values, 200 to 500 values, 200 to 1000 values, 200 to 2000 values, 500 to 1000 values, 500 to 2000 values, or 1000 to 2000 values. In some cases, the real and/or imaginary dielectric functions for one or more foulants and a coating surface may be approximated by an optical functionality package within a computational method software package. Non-limiting examples of suitable computational method software packages include the Vienna Ab Initio Simulation Package (VASP), Quantum ESPRESSO, and CASTEP. Other atomistic and/or ab initio software packages that can return frequency-dependent indices of refraction and/or dielectric spectra may also be used to calculate a full-spectral Hamaker constant for a system.

In some embodiments, a full-spectral Hamaker constant for a system comprising a fluid comprising one or more foulants and a coating disposed on a substrate may be calculated using one or more experimental methods. Examples of suitable experimental methods include, but are not limited to, white light spectroscopy, atomic force microscope force spectroscopy (AFM-FS), valence electron energy loss spectroscopy (VEELS), ellipsometry, a surface force apparatus method, a drop-test method, a centrifugal method, an electric field detachment method, an aerodynamic detachment method, and a vibration method. In certain embodiments, an experimental method (e.g., white light spectroscopy) is used to measure the refractive indices nᵣ of a material of a coating and/or one or more foulants across a range of wavelengths. Dielectric response values may be calculated from the refractive indices according to Equation 5. In certain embodiments, an experimental method (e.g., ellipsometry) is used to directly measure dielectric response values of a material of a coating and/or one or more foulants across a range of wavelengths. The full-spectral Hamaker constant may then be computed from the dielectric response values according to Equations 2, 3, and 6. In certain embodiments, an experimental method (e.g., AFM-FS) is used to directly measure adhesion force (which may be dominated by F_{vdW}) of a foulant particle to a coating. Suitable experimental methods are described in Zafar et al., Drop test: A new method to measure the particle adhesion force, POWDER TECHNOLOGY, 264: 236-241 (2014) (describing an exemplary drop-test method); Salazar-Banda et al., Determination of the adhesion force between particles and a flat surface, using the centrifuge technique, POWDER TECHNOLOGY, 173: 107-117 (2007) (describing an exemplary centrifugal method); M. Takeuchi, Adhesion forces of charged particles, CHEM. ENG. SCI., 61: 2279-89 (2005) (describing an exemplary electric field detachment method); S. Nimisha et al., Effect of relative particle size on large particle detachment from a microchannel, MICROFLUID. NANOFLUID., 6: 521-527 (2009) (describing an exemplary aerodynamic detachment method); and Otles et al., Adhesive forces and surface modification in dry particle coating, PROC.: PARTICULATE SYSTEMS ANALYSIS (2008) (Warwickshire, UK) (describing an exemplary vibration method), the contents of all of which are incorporated herein by reference in their entireties for all purposes.

In some embodiments, an experimental method may be used to measure a refractive index and/or a dielectric response value of a material of a coating and/or one or more foulants comprising at least 10, at least 20, at least 50, at least 100, at least 200, at least 500, or at least 1000 wavelengths and/or frequencies. In certain embodiments, an experimental method may be used to measure a refractive index and/or a dielectric response value of a material of a coating and/or one or more foulants for wavelengths in a range from 10 nm to 100 nm, 10 nm to 300 nm, 10 nm to 400 nm, 10 nm to 500 nm, 10 nm to 700 nm, 10 nm to 1 µm, 10 nm to 2 µm, 10 nm to 3 µm, 10 nm to 4 µm, 10 nm to 5 µm, 100 nm to 300 nm, 100 nm to 400 nm, 100 nm to 500 nm, 100 nm to 700 nm, 100 nm to 1 µm, 100 nm to 2 µm, 100 nm to 3 µm, 100 nm to 4 µm, 100 nm to 5 µm, 190 nm to 400 nm, 190 nm to 700 nm, 190 nm to 1 µm, 190 nm to 2 µm, 190 nm to 3 µm, 190 nm to 4 µm, 190 nm to 5 µm, 300 nm to 400 nm, 300 nm to 500 nm, 300 nm to 700 nm, 300 nm to 1 µm, 300 nm to 2 µm, 300 nm to 3 µm, 300 nm to 4 µm, 300 nm to 5 µm, 400 nm to 500 nm, 400 nm to 700 nm, 400 nm to 1 µm, 400 nm to 2 µm, 400 nm to 3 µm, 400 nm to 4 µm, 400 nm to 5 µm, 500 nm to 700 nm, 500 nm to 1 µm, 500 nm to 2 µm, 500 nm to 3 µm, 500 nm to 4 µm, 500 nm to 5 µm, 700 nm to 1 µm, 700 nm to 2 µm, 700 nm to 3 µm, 700 nm to 4 µm, 700 nm to 5 µm, or 1 µm to 5 µm.

In some embodiments, a full-spectral Hamaker constant associated with a coating and a fluid comprising one or more foulants is relatively low. In certain embodiments, the full-spectral Hamaker constant associated with a coating and a fluid comprising one or more foulants is about 20 zeptojoules (zJ) or less, about 15 zJ or less, about 10 zJ or less, about 5 zJ or less, about 2 zJ or less, about 1 zJ or less, or about 0.5 zJ or less. In certain embodiments, the full-spectral Hamaker constant associated with a coating and a fluid comprising one or more fluids is in a range from 0.1 zJ to 0.5 zJ, 0.1 zJ to 1 zJ ,0.1 zJ to 2 zJ, 0.1 zJ to 5 zJ, 0.1 zJ to 10 zJ, 0.1 zJ to 15 zJ, 0.1 zJ to 20 zJ, 0.5 zJ to 1 zJ, 0.5 zJ to 2 zJ, 0.5 zJ to 5 zJ, 0.5 zJ to 10 zJ, 0.5 zJ to 15 zJ, 0.5 zJ to 20 zJ, 1 zJ to 2 zJ, 1 zJ to 5 zJ, 1 zJ to 10 zJ, 1 zJ to 15 zJ, 1 zJ to 20 zJ, 5 zJ to 10 zJ, 5 zJ to 15 zJ, 5 zJ to 20 zJ, or 10 zJ to 20 zJ.

According to some aspects, a relatively low full-spectral Hamaker constant may be achieved by selecting a material for the coating that has optical properties (e.g., indices of refraction, dielectric response values) similar to those of the foulant-comprising fluid across a range of frequencies (and/or corresponding wavelengths). As shown in Equation 2, Hamaker constant A_{Ham} may be approximated by a sum from n=0 to infinity of the product of Δ_{af}(ξₙ), Δ_{fb}(ξₙ), and, optionally, Rₙ(l,ξₙ). The term Δ_{af}(ξₙ) may be calculated as follows:

$${Δ}_{a f} \left({ξ}_{n}\right) = \frac{{ε}_{a} \left(i {E}_{n}\right) - {ε}_{f} \left(i {E}_{n}\right)}{{ε}_{a} \left(i {E}_{n}\right) + {ε}_{f} \left(i {E}_{n}\right)}$$

where a is a material of the coating surface and f is the intervening fluid. Thus, if the imaginary dielectric spectrum of material a of the coating surface is equal to the imaginary dielectric spectrum of fluid f, Δ_{af}(ξₙ) would be zero for each value of n, and A_{Ham} would be zero. F_{vdW} would, therefore, also be zero, and no foulant particles would adhere to the coating surface. Similarly, if the imaginary dielectric spectrum of material b of a foulant is equal to the imaginary dielectric spectrum of fluid f, Δ_{fb} (ξₙ) would be zero for each value of n, and A_{Ham} and F_{vdW} would also be zero. Because the real and imaginary components of the dielectric spectrum are linked via Equation 6, finding a match between the dielectric spectra of the fluid and the dielectric spectra of a material of the coating or a foulant may lead to little or no adhesion of foulant particles to the coating surface via vdW forces. Since, for a given system, it may be challenging (or impossible) to vary a fluid and/or a foulant without significantly compromising the system, it may be desirable to select a suitable material for the coating (i.e., a material having optical properties matching those of the fluid) in order to reduce or eliminate fouling. In some cases, a material of the coating may have optical properties that “match” those of the fluid if the optical properties of the coating material are substantially similar (but not necessarily equal) to the optical properties of the fluid.

In some embodiments, a mean percentage difference between an optical property spectrum of a material of a coating and an optical property spectrum of a fluid is relatively low. The mean percentage difference (MPD) may be calculated according to Equation 13:

$$M P D = \frac{100}{n} {\sum }_{i = 1}^{n} \frac{\left|{x}_{f i} - {x}_{a i}\right|}{{x}_{f i}}$$

where x_{fi} is an optical property of the fluid at a given wavelength (or frequency) and xₐᵢ is an optical property of a material of the coating at the given wavelength (or frequency). In some embodiments, the optical property is index of refraction or dielectric response. In some embodiments, the mean percentage difference between an optical property spectrum of a material of a coating and an optical property spectrum of a fluid is about 20% or less, about 15% or less, about 10% or less, about 5% or less, about 2% or less, or about 1% or less. In certain embodiments, the mean percentage difference between an optical property spectrum of a material of a coating and an optical property spectrum of a fluid is in a range from 1% to 2%, 1% to 5%, 1% to 10%, 1% to 15%, 1% to 20%, 5% to 10%, 5% to 15%, 5% to 20%, or 10% to 20%.

In some embodiments, a root-mean-square deviation of an optical property spectrum of a material of a coating from an optical property spectrum of a fluid is relatively small. In some embodiments, the optical property is index of refraction or dielectric response. As an illustrative example, a root-mean-square deviation (RMSD) of a refractive index spectrum of a material of a coating from a refractive index spectrum of a fluid may be calculated according to Equation 14:

$$R M S D = \sqrt{{\sum }_{λ} {\left({n}_{r a} \left(λ\right) - {n}_{r f} \left(λ\right)\right)}^{2}}$$

where nᵣₐ(λ) is the index of refraction of a coating material a at wavelength λ, and n_{rf}(λ) is the index of refraction of fluid f at wavelength λ. In some embodiments, a root-mean-square deviation of a refractive index spectrum of a material of a coating from a refractive index spectrum of a fluid is about 0.5 or less, 0.4 or less, 0.3 or less, 0.2 or less, or 0.1 or less. In certain embodiments, the root-mean-square deviation of a refractive index spectrum of a material of a coating from a refractive index spectrum of a fluid is in a range from 0.1 to 0.2, 0.1 to 0.3, 0.1 to 0.4, or 0.1 to 0.5.

In some embodiments, a mean percentage difference and/or a root-mean-square deviation value may be calculated over a range of wavelengths in a range from 10 nm to 100 nm, 10 nm to 300 nm, 10 nm to 400 nm, 10 nm to 500 nm, 10 nm to 700 nm, 10 nm to 1 µm, 10 nm to 2 µm, 10 nm to 3 µm, 10 nm to 4 µm, 10 nm to 5 µm, 100 nm to 300 nm, 100 nm to 400 nm, 100 nm to 500 nm, 100 nm to 700 nm, 100 nm to 1 µm, 100 nm to 2 µm, 100 nm to 3 µm, 100 nm to 4 µm, 100 nm to 5 µm, 190 nm to 400 nm, 190 nm to 500 nm, 190 nm to 700 nm, 190 nm to 1 µm, 190 nm to 2 µm, 190 nm to 3 µm, 190 nm to 4 µm, 190 nm to 5 µm, 300 nm to 400 nm, 300 nm to 500 nm, 300 nm to 700 nm, 300 nm to 1 µm, 300 nm to 2 µm, 300 nm to 3 µm, 300 nm to 4 µm, 300 nm to 5 µm, 400 nm to 700 nm, 400 nm to 1 µm, 400 nm to 2 µm, 400 nm to 3 µm, 400 nm to 4 µm, 400 nm to 5 µm, 500 nm to 700 nm, 500 nm to 1 µm, 500 nm to 2 µm, 500 nm to 3 µm, 500 nm to 4 µm, 500 nm to 5 µm, 700 nm to 1 µm, 700 nm to 2 µm, 700 nm to 3 µm, 700 nm to 4 µm, 700 nm to 5 µm, or 1 µm to 5 µm.

In some embodiments, a composite coating comprises a plurality of materials. In certain cases, a composite coating comprises a first material and a second material. In some instances, the first material is different from the second material. According to some embodiments, the first material is associated with a first set of optical properties (e.g., indices of refraction, dielectric response values) over a range of wavelengths, and the second material is associated with a second set of optical properties (e.g., indices of refraction, dielectric response values) over the range of wavelengths. In certain embodiments, optical properties of the composite coating may be calculated by computing averages based on the two sets of optical properties. In some instances, the averages may be weighted averages. As an illustrative, non-limiting example, Equation 15 shows an exemplary calculation of a weighted average dielectric response value for a composite coating comprising i materials:

$${∈}_{a v g} \left({ξ}_{n}\right) = \frac{Σ {v}_{i} {∈}_{i} \left({ξ}_{n}\right)}{Σ {v}_{i}}$$

where ∈_{avg}(ξₙ) is the weighted average dielectric response value at a given frequency ξₙ, vᵢ is the volume fraction of the i^{th} material, and ∈ᵢ(ξₙ) is the dielectric response of the i^{th} material at ξₙ. Although Equation 15 shows an average optical property being weighted by volume fraction, the average optical property may be weighted by other values, including but not limited to number fraction, mass fraction, distance of the i^{th} material from the surface of the composite coating, and volume-integrated mass fraction-at-distance from the surface.

In some embodiments, a spectrum of average optical property values (e.g., weighted average optical property values) of a composite coating over a range of wavelengths is substantially similar to a spectrum of optical property values of a fluid in physical contact with the composite coating over the range of wavelengths. In certain cases, a spectrum of average optical property values (e.g., weighted average optical property values) may advantageously provide a closer match to a spectrum of optical property values of a fluid than those of a single material. In certain instances, the composition of a composite coating (e.g., type and volume of material forming the composite coating) may be tuned to match the optical properties of a particular fluid. In some cases, although the optical properties of a first material of a composite coating and the optical properties of a second material of the composite coating may be substantially different from the optical properties of a particular fluid of interest, average (e.g., weighted average) optical properties of the composite coating may be substantially similar to those of the particular fluid.

In some embodiments, a mean percentage difference between average optical property values (e.g., weighted average optical property values) of a composite coating over a range of wavelengths (or frequencies) and optical property values of a fluid over the same range of wavelengths (or frequencies) is relatively low. The mean percentage difference (MPD) may be calculated according to Equation 16:

$$M P D = \frac{100}{n} {\sum }_{i = 1}^{n} \frac{\left|{x}_{f i} - {x}_{a v g i}\right|}{{x}_{f i}}$$

where x_{fi} is an optical property of the fluid at a given wavelength (or frequency) and x_{avg} ᵢ is an average (e.g., a weighted average) of the optical property of the first material of the composite coating at the given wavelength (or frequency) and the optical property of the second material of the composite coating at the given wavelength (or frequency) (and the optical properties of any additional materials of the composite coating). In some embodiments, the optical property is index of refraction or dielectric response. In some embodiments, the mean percentage difference between average optical property values of a composite coating and optical property values of a fluid is about 20% or less, about 15% or less, about 10% or less, about 5% or less, about 2% or less, or about 1% or less. In certain embodiments, the mean percentage difference between average optical property values of a composite coating and optical property values of a fluid is in a range from 1% to 2%, 1% to 5%, 1% to 10%, 1% to 15%, 1% to 20%, 5% to 10%, 5% to 15%, 5% to 20%, or 10% to 20%.

In certain embodiments, a root-mean-square deviation of average optical property values (e.g., weighted average optical property values) of a composite coating over a range of wavelengths from optical property values of a fluid over the same range of wavelengths is relatively small. In some embodiments, the optical property is index of refraction or dielectric response. As an illustrative, non-limiting example, an equation for calculating the root-mean-square deviation of an index of refraction is shown in Equation 17:

$$R M S D = \sqrt{{\sum }_{λ} {\left({n}_{r a v g} \left(λ\right) - {n}_{r f} \left(λ\right)\right)}^{2}}$$

where nᵣ _{avg}(λ) is the average (e.g., weighted average) of the index of refraction for a composite coating at wavelength λ, and n_{rf}(λ) is the index of refraction of fluid f at wavelength λ. In some embodiments, the RMSD of an average (e.g., weighted average) refractive index spectrum of a composite coating from a refractive index spectrum of a fluid is about 0.5 or less, 0.4 or less, 0.3 or less, 0.2 or less, or 0.1 or less. In some instances, the RMSD of an average (e.g., weighted average) refractive index spectrum of a composite coating from a refractive index spectrum of a fluid is in a range from 0.1 to 0.2, 0.1 to 0.3, 0.1 to 0.4, or 0.1 to 0.5.

In some embodiments, a mean percentage difference and/or a root-mean-square deviation value may be calculated over a range of wavelengths in a range from 10 nm to 100 nm, 10 nm to 300 nm, 10 nm to 400 nm, 10 nm to 500 nm, 10 nm to 700 nm, 10 nm to 1 µm, 10 nm to 2 µm, 10 nm to 3 µm, 10 nm to 4 µm, 10 nm to 5 µm, 100 nm to 300 nm, 100 nm to 400 nm, 100 nm to 500 nm, 100 nm to 700 nm, 100 nm to 1 µm, 100 nm to 2 µm, 100 nm to 3 µm, 100 nm to 4 µm, 100 nm to 5 µm, 190 nm to 400 nm, 190 nm to 500 nm, 190 nm to 700 nm, 190 nm to 1 µm, 190 nm to 2 µm, 190 nm to 3 µm, 190 nm to 4 µm, 190 nm to 5 µm, 300 nm to 400 nm, 300 nm to 500 nm, 300 nm to 700 nm, 300 nm to 1 µm, 300 nm to 2 µm, 300 nm to 3 µm, 300 nm to 4 µm, 300 nm to 5 µm, 400 nm to 700 nm, 400 nm to 1 µm, 400 nm to 2 µm, 400 nm to 3 µm, 400 nm to 4 µm, 400 nm to 5 µm, 500 nm to 700 nm, 500 nm to 1 µm, 500 nm to 2 µm, 500 nm to 3 µm, 500 nm to 4 µm, 500 nm to 5 µm, 700 nm to 1 µm, 700 nm to 2 µm, 700 nm to 3 µm, 700 nm to 4 µm, 700 nm to 5 µm, or 1 µm to 5 µm.

According to some aspects, selecting composite coating materials that result in average optical property values that are similar to optical property values of a foulant-comprising fluid across a range of frequencies (and/or corresponding wavelengths) may advantageously result in a relatively low full-spectral Hamaker constant. As shown in Equation 2, Hamaker constant A_{Ham} may be approximated by a sum from n=0 to infinity of the product of Δ_{af}(ξₙ), Δ_{fb}(ξₙ), and, optionally, Rₙ(l,ξₙ). The term Δ_{af}(ξₙ) may be calculated as follows:

$${Δ}_{a f} \left({ξ}_{n}\right) = \frac{{∈}_{a} \left(i {E}_{n}\right) - {∈}_{f} \left(i {E}_{n}\right)}{{∈}_{a} \left(i {E}_{n}\right) + {∈}_{f} \left(i {E}_{n}\right)}$$

where a is a composite coating and f is the intervening fluid. Thus, if the imaginary dielectric spectrum of composite coating a (i.e., based on an average, such as a weighted average) is equal to the imaginary dielectric spectrum of fluid f, Δ_{af}(ξₙ) would be zero for each value of n, and A_{Ham} would be zero. F_{vdW} would, therefore, also be zero, and no foulant particles would adhere to the composite coating surface. Similarly, if the imaginary dielectric spectrum of material b of a foulant is equal to the imaginary dielectric spectrum of fluid f, Δ_{fb}(ξₙ) would be zero for each value of n, and A_{Ham} and F_{vdW} would also be zero. Because the real and imaginary components of the dielectric spectrum are linked via Equation 6, finding a match between the dielectric spectra of the fluid and the dielectric spectra of a composite coating or a foulant may lead to little or no adhesion of foulant particles to the coating surface via vdW forces. Since, for a given system, it may be challenging (or impossible) to vary a fluid and/or a foulant without significantly compromising the system, it may be desirable to select suitable materials for the composite coating in order to reduce or eliminate fouling. In some cases, a composite coating may have optical properties that “match” those of the fluid if the optical properties of the coating material are substantially similar (but not necessarily equal to) the optical properties of the fluid.

In some embodiments, a composite coating comprises a first region comprising a first material and a second region comprising a second material, where the first material is different from the second material. In some embodiments, the composite coating comprises a plurality of first regions and/or a plurality of second regions. In some cases, boundaries between the first regions and the second regions (i.e., locations where mixing and/or strain may occur) comprise less than 20%, less than 10%, less than 5%, or less than 1% of total coating volume.

The first region(s) and second region(s) of a composite coating may be arranged according to any geometry. Each of the first region(s) and the second region(s) of a composite coating may have any suitable size and shape. In some embodiments, an average longest dimension of a first region and/or a second region is in a range from 1 nm to 5 nm, 1 nm to 10 nm, 1 nm to 15 nm, 1 nm to 20 nm, 1 nm to 50 nm, 1 nm to 80 nm, 1 nm to 100 nm, 10 nm to 20 nm, 10 nm to 50 nm, 10 nm to 80 nm, 10 nm to 100 nm, 20 nm to 50 nm, 20 nm to 80 nm, 20 nm to 100 nm, 50 nm to 80 nm, or 50 nm to 100 nm. In certain embodiments, an average longest dimension of a first region and/or a second region is less than ⅒ the average size of foulant particles in the system. As an illustrative example, in a nuclear reactor in which average foulant particle sizes may range from 100 nm to 1 µm, the average longest dimension of a first region and/or a second region of a composite coating may be in a range from 10 nm to 100 nm.

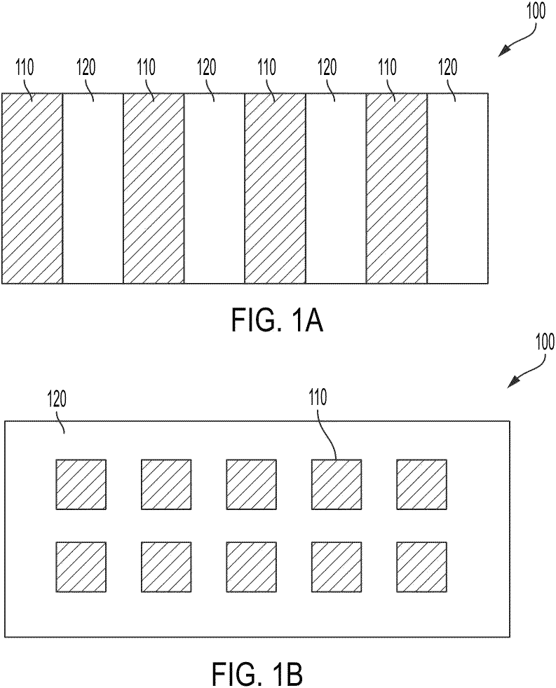

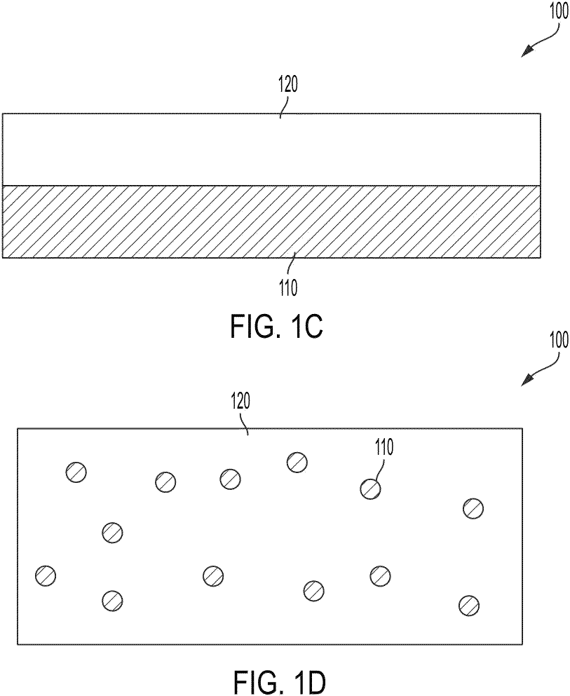

Exemplary, non-limiting arrangements of first region(s) and second region(s) of a composite coating are illustrated in FIGS. 1A-1D. Each of FIGS. 1A-1D shows an exemplary composite coating 100 comprising first region(s) 110 comprising a first material and second region(s) 120 comprising a second material that is different from the first material. FIG. 1A is a schematic illustration of a top-down view of composite coating 100. As shown in FIG. 1A, composite coating 100 comprises a plurality of first regions 110 arranged in a regular alternating pattern with a plurality of second regions 120. FIG. 1B is also a schematic illustration of a top-down view of composite coating 100. As shown in FIG. 1B, composite coating 100 comprises a plurality of first regions 110 arranged in a regular pattern within second region 120. Although FIGS. 1A and 1B show a plurality of first regions 110 arranged in a regular pattern, it should be appreciated that first regions 110 and second region(s) 120 may be arranged in any pattern and, in some cases, may be irregularly arranged.

In some embodiments, at least one aspect of first region(s) 110 and second region(s) 120 may vary across the thickness of the composite coating. In certain embodiments, the composite coating comprises a plurality of layers. In some instances, the composite coating comprises a first layer and a second layer disposed on the first layer. As an illustrative example, FIG. 1C is a schematic illustration of a cross-sectional view of composite coating 100. In FIG. 1C, composite coating 100 comprises first layer 110 and second layer 120 disposed on first layer 110. Each layer of a composite coating may have any suitable thickness. In certain embodiments, at least one layer (and, in some instances, each layer) of a plurality of layers has a thickness of at least 3 nm, at least 5 nm, at least 10 nm, at least 15 nm, at least 20 nm, at least 50 nm, at least 80 nm, or at least 100 nm. In certain embodiments, at least one layer (and, in some instances, each layer) of a plurality of layers has a thickness in a range from 3 nm to 5 nm, 3 nm to 10 nm, 3 nm to 15 nm, 3 nm to 20 nm, 3 nm to 50 nm, 3 nm to 80 nm, 3 nm to 100 nm, 5 nm to 10 nm, 5 nm to 15 nm, 5 nm to 20 nm, 5 nm to 50 nm, 5 nm to 80 nm, 5 nm to 100 nm, 10 nm to 20 nm, 10 nm to 50 nm, 10 nm to 80 nm, 10 nm to 100 nm, 20 nm to 50 nm, 20 nm to 80 nm, 20 nm to 100 m, or 50 nm to 100 nm. In some embodiments, a composite coating has at least 2, at least 3, at least 5, at least 10, or at least 10 layers.

In certain embodiments, the composite coating comprises particles of a first material dispersed in a matrix of a second material. As an illustrative example, FIG. 1D is a schematic illustration of a cross-sectional view of composite coating 100. In FIG. 1D, composite coating 100 comprises particles 110 of a first material dispersed in matrix 120 of a second material. Particles of a first material and/or second material in a composite coating may have any suitable size and shape. In certain embodiments, at least some particles of a first material and/or a second material in a composite coating are substantially spherical, substantially ellipsoidal, and/or irregularly shaped. In some instances, particles of the first material and/or the second material have an average particle diameter in a range from 1 nm to 5 nm, 1 nm to 10 nm, 1 nm to 15 nm, 1 nm to 20 nm, 1 nm to 50 nm, 1 nm to 80 nm, 1 nm to 100 nm, 10 nm to 20 nm, 10 nm to 50 nm, 10 nm to 80 nm, 10 nm to 100 nm, 20 nm to 50 nm, 20 nm to 80 nm, 20 nm to 100 nm, 50 nm to 80 nm, or 50 nm to 100 nm.

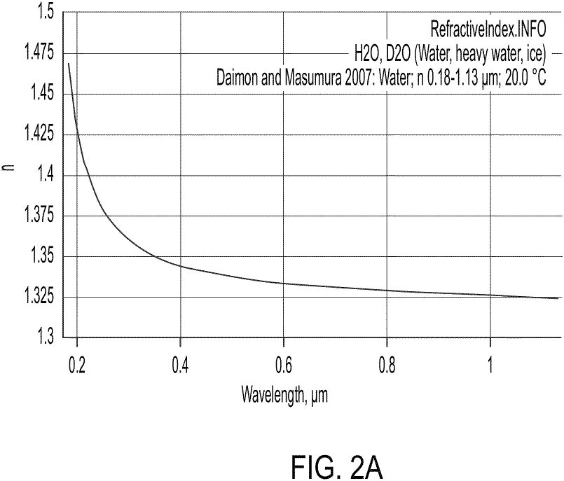

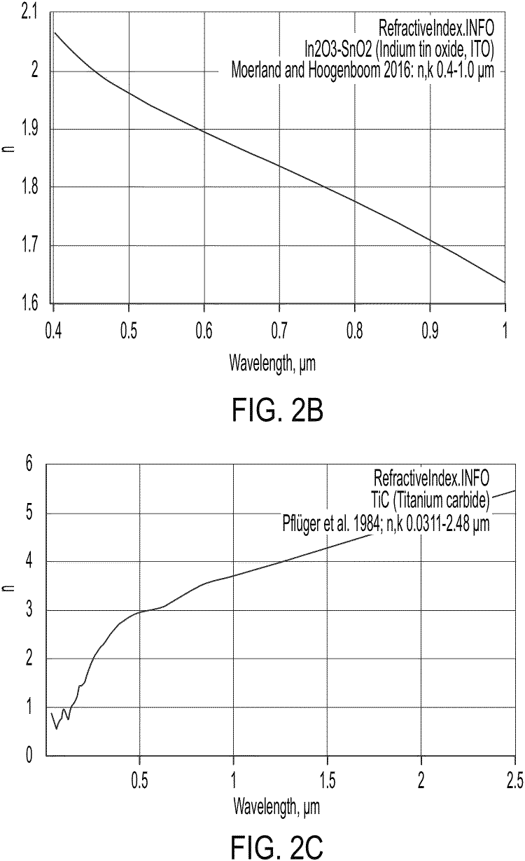

The first material and the second material of a composite coating may be selected to produce average optical properties (e.g., weighted average optical properties) that are substantially similar to the optical properties of a fluid. In some cases, a refractive index spectrum and/or a dielectric spectrum of the first material and the second material may vary in different directions over a given range of wavelengths (e.g., one spectrum may increase while the other decreases). As an illustrative example, FIG. 2A shows a refractive index spectrum for water at 20° C., FIG. 2B shows a refractive index spectrum for ITO, and FIG. 2C shows a refractive index spectrum for TiC. The inventors have recognized and appreciated that the refractive index spectrum for ITO generally decreases and the refractive index spectrum for TiC generally increases over wavelengths ranging from 500 nm to 1 µm. Since the refractive index spectrum for water (as shown in FIG. 2A) is relatively flat in the wavelength range of 500 nm to 1 µm, average refractive index values computed from the ITO and TiC spectra may be closer to the values of the water spectrum than the individual refractive index values of the ITO and TiC spectra.

In certain instances, when the fluid is water, the first material is indium tin oxide (ITO), and the second material is silicon nitride (SiN). In some embodiments, the first material and/or the second material is fluorine-doped tin oxide (FTO), indium tin oxide (ITO), calcium fluoride (CaF₂), cryolite (Na₃AlF₆), fluorinated diamond-like carbon (F-DLC), amorphous carbon (a-C), zirconium nitride (ZrN), titanium carbide (TiC), and/or titanium nitride (TiN).

The first material and the second material may independently be amorphous or crystalline. In some embodiments, the first material and/or the second material are amorphous. In certain cases, the first material and/or the second material comprise (or, in some cases, consist of) an amorphous material. Non-limiting examples of amorphous materials include amorphous carbon, amorphous F-DLC, and amorphous FTO. In some embodiments, the amorphous carbon is tetrahedral amorphous carbon (TA-C). In some cases, a coating comprising (or, in some cases, consisting of) an amorphous material may advantageously exhibit lower adhesion to foulant particles than a coating comprising (or, in some cases, consisting of) a crystalline material (e.g., nanocrystalline diamond, polycrystalline diamond). In certain embodiments, the first material and/or the second material do not comprise a crystalline material (e.g., nanocrystalline diamond, polycrystalline diamond). In certain other embodiments, the first material and/or the second material comprise a substantially crystalline material. In some instances, the first material and/or the second material comprise crystalline CaF₂ and/or crystalline Na₃AlF₆.

In some embodiments, the first material and/or the second material comprise (or, in some cases, consist of) a material that does not comprise a hydrogen bond acceptor (i.e., a material whose chemical structure does not comprise an atom that can act as a hydrogen bond acceptor). Examples of atoms that can act as a hydrogen bond acceptor include, but are not limited to, oxygen and nitrogen. In some embodiments, the first material and/or the second material comprise (or, in some cases, consist of) an oxygen-free material (i.e., a material whose chemical structure does not comprise an oxygen atom). Non-limiting examples of oxygen-free materials include amorphous carbon, F-DLC, TiC, TiN, ZrN, Na₃AlF₆, and CaF₂. In certain cases, a coating comprising a material that does not comprise oxygen (or other atoms that can act as hydrogen bond acceptors) may advantageously exhibit a relatively low adhesive force between the coating and foulant particles (particularly under high temperature conditions). Without wishing to be bound by a particular theory, the presence of one or more oxygen atoms (or other atoms that can act as hydrogen bond acceptors) in a coating may enable OH-mediated hydrogen bonding, which may enhance adhesive forces between the coating and foulant particles (particularly under high temperature conditions).

In some embodiments, the first material and the second material are chemically and structurally distinct and are not atomically mixed. The first material and the second material may be present in the composite coating in any suitable amount. In some embodiments, the volume fraction of the first material and/or the second material (and any additional materials of the composite coating) is at least 0.1, at least 0.2, at least 0.3, at least 0.4, at least 0.5, at least 0.6, at least 0.7, at least 0.8, or at least 0.9. In certain embodiments the volume fraction of the first material and/or the second material (and any additional materials of the composite coating) is in a range from 0.1 to 0.2, 0.1 to 0.3, 0.1 to 0.4, 0.1 to 0.5, 0.1 to 0.6, 0.1 to 0.7, 0.1 to 0.8, 0.1 to 0.9, 0.2 to 0.3, 0.2 to 0.4, 0.2 to 0.5, 0.2 to 0.6, 0.2 to 0.7, 0.2 to 0.8, 0.2 to 0.9, 0.3 to 0.5, 0.3 to 0.6, 0.3 to 0.7, 0.3 to 0.8, 0.3 to 0.9, 0.4 to 0.6, 0.4 to 0.7, 0.4 to 0.8, 0.4 to 0.9, 0.5 to 0.9, 0.6 to 0.9, 0.7 to 0.9, or 0.8 to 0.9.

In some embodiments, a composite coating comprises more than 2 different materials. In certain embodiments, the composite coating comprises at least 3 different materials, at least 4 different materials, at least 5 different materials, or at least 10 different materials.

In some embodiments, a first material and/or a second material of a composite coating disposed on a substrate has a relatively high melting point. In some cases, it may be advantageous for the first material and/or second material of the composite coating to have a melting point that is higher than the highest temperature that the substrate or fluid will reach. In certain embodiments, the first material and/or second material of the composite coating has a melting point of at least 250° C., at least 300° C., at least 315° C., at least 330° C., at least 350° C., at least 400° C., at least 500° C., at least 600° C., at least 700° C., at least 800° C., at least 900° C., at least 1000° C., at least 1100° C., at least 1200° C., at least 1300° C., at least 1400° C., at least 1500° C., at least 1600° C., at least 1700° C., at least 1800° C., at least 1900° C., at least 2000° C., at least 2100° C., at least 2200° C., at least 2300° C., at least 2400° C., or at least 2500° C. In some embodiments, the first material and/or second material of the composite coating has a melting point in a range from 250° C. to 350° C., 250° C. to 500° C., 250° C. to 1000° C., 250° C. to 1500° C., 250° C. to 2000° C., 250° C. to 2200° C., 250° C. to 2500° C., 300° C. to 350° C., 300° C. to 500° C., 300° C. to 1000° C., 300° C. to 1500° C., 300° C. to 2000° C., 300° C. to 2200° C., 300° C. to 2500° C., 350° C. to 500° C., 350° C. to 1000° C., 350° C. to 1500° C., 350° C. to 2000° C., 350° C. to 2200° C., 350° C. to 2500° C., 500° C. to 1000° C., 500° C. to 1500° C., 500° C. to 2000° C., 500° C. to 2200° C., 500° C. to 2500° C., 1000° C. to 2000° C., 1000° C. to 2200° C., 1000° C. to 2500° C., 1500° C. to 2000° C., 1500° C. to 2200° C., 1500° C. to 2500° C., 2000° C. to 2200° C., or 2000° C. to 2500° C. The melting point of the first material and/or second material of the composite coating may be measured according to any method known in the art. For example, melting point may be measured by differential scanning calorimetry (DSC).

In some embodiments, the composite coating is relatively thick. In some cases, a relatively thick coating may effectively mask the dielectric characteristics of the substrate upon which the composite coating is disposed. In certain cases, however, the composite coating is not so thick that it exceeds the epitaxial thin film limit and cracks due to thick film stresses. In some embodiments, the composite coating has a thickness of at least 50 nm, at least 100 nm, at least 150 nm, at least 200 nm, at least 300 nm, at least 400 nm, at least 500 nm, at least 600 nm, at least 700 nm, at least 800 nm, at least 900 nm, at least 1 µm, at least 2 µm, at least 5 µm, or at least 10 µm. In some embodiments, the composite coating has a thickness in a range from 50 nm to 100 nm, 50 nm to 150 nm, 50 nm to 200 nm, 50 nm to 300 nm, 50 nm to 400 nm, 50 nm to 500 nm, 50 nm to 600 nm, 50 nm to 700 nm, 50 nm to 800 nm, 50 nm to 900 nm, 50 nm to 1 µm, 50 nm to 2 µm, 50 nm to 5 µm, 50 nm to 10 µm, 100 nm to 150 nm, 100 nm to 200 nm, 100 nm to 300 nm, 100 nm to 400 nm, 100 nm to 500 nm, 100 nm to 600 nm, 100 nm to 700 nm, 100 nm to 800 nm, 100 nm to 900 nm, 100 nm to 1 µm, 100 nm to 2 µm, 100 nm to 5 µm, 100 nm to 10 µm, 200 nm to 300 nm, 200 nm to 400 nm, 200 nm to 500 nm, 200 nm to 600 nm, 200 nm to 700 nm, 200 nm to 800 nm, 200 nm to 900 nm, 200 nm to 1 µm, 200 nm to 2 µm, 200 nm to 5 µm, 200 nm to 10 µm, 300 nm to 400 nm, 300 nm to 500 nm, 300 nm to 600 nm, 300 nm to 700 nm, 300 nm to 800 nm, 300 nm to 900 nm, 300 nm to 1 µm, 300 nm to 2 µm, 300 nm to 5 µm, 300 nm to 10 µm, 400 nm to 500 nm, 400 nm to 600 nm, 400 nm to 700 nm, 400 nm to 800 nm, 400 nm to 900 nm, 400 nm to 1 µm, 400 nm to 2 µm, 400 nm to 5 µm, 400 nm to 10 µm, 500 nm to 600 nm, 500 nm to 700 nm, 500 nm to 800 nm, 500 nm to 900 nm, 500 nm to 1 µm, 500 nm to 2 µm, 500 nm to 5 µm, 500 nm to 10 µm, 600 nm to 700 nm, 600 nm to 800 nm, 600 nm to 900 nm, 600 nm to 1 µm, 600 nm to 2 µm, 600 nm to 5 µm, 600 nm to 10 µm, 700 nm to 800 nm, 700 nm to 900 nm, 700 nm to 1 µm, 700 nm to 2 µm, 700 nm to 5 µm, 700 nm to 10 µm, 800 nm to 900 nm, 800 nm to 1 µm, 800 nm to 2 µm, 800 nm to 5 µm, 800 nm to 10 µm, 900 nm to 1 µm, 900 nm to 2 µm, 900 nm to 5 µm, 900 nm to 10 µm, 1 µm to 2 µm, 1 µm to 5 µm, 1 µm to 10 µm, or 5 µm to 10 µm.

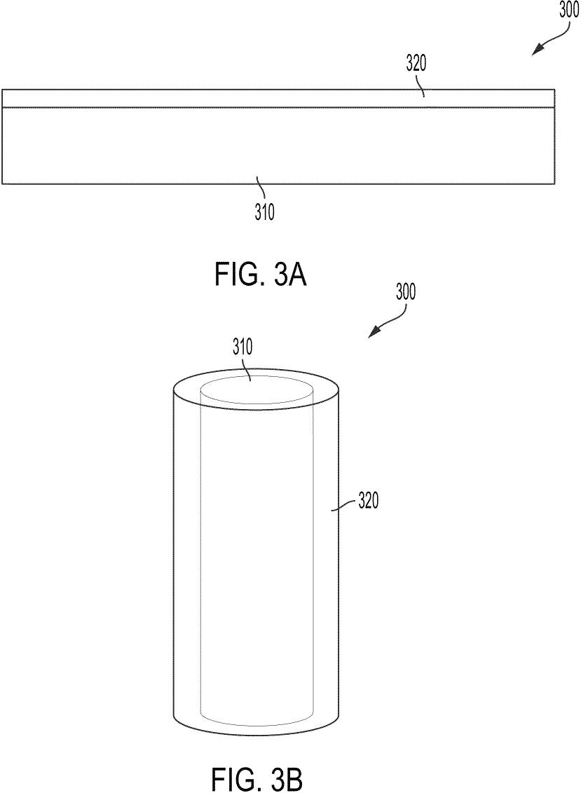

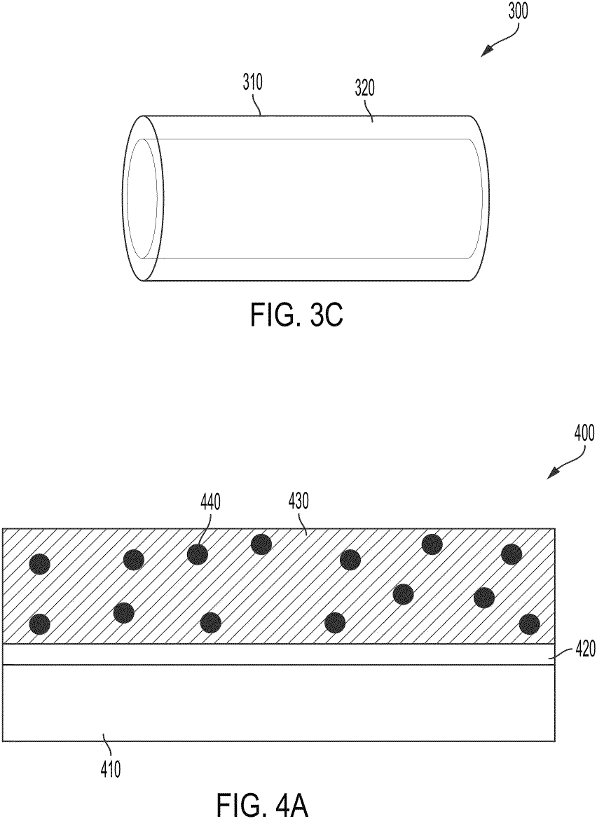

According to some embodiments, the composite coating is disposed on at least a portion of a substrate. In some cases, the substrate comprises a surface of a body. The substrate (and/or the body) may have substantially any geometry. FIGS. 3A-3C each show an exemplary article 300 comprising substrate 310 and composite coating 320, where composite coating 320 is disposed on substrate 310. As shown in FIG. 3A, at least a portion of substrate 310 may be substantially planar. Alternatively, as shown in FIGS. 3B and 3C, at least a portion of substrate 310 may be substantially cylindrical. As shown in FIG. 3B, composite coating 320 may be disposed on an outer surface of cylindrical substrate 310. As shown in FIG. 3C, composite coating 320 may be disposed on an inner surface of cylindrical substrate 310.

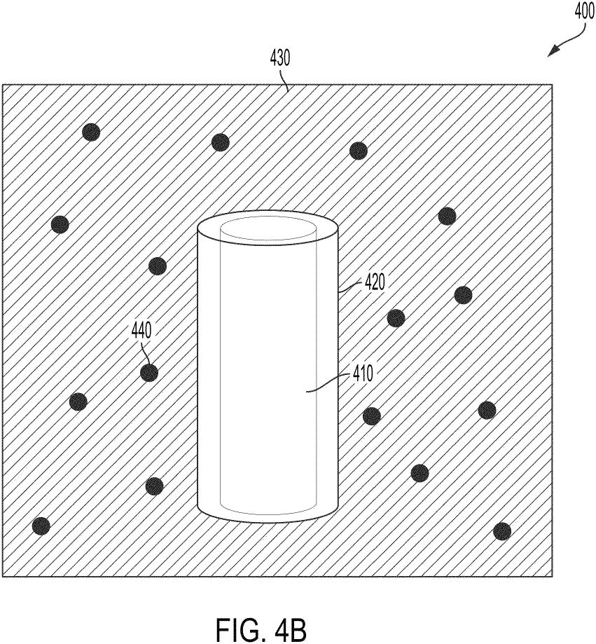

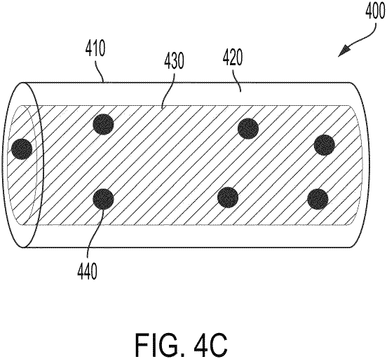

Certain embodiments relate to systems comprising a substrate, a coating disposed on at least a portion of the substrate, and a fluid comprising one or more foulants. FIGS. 4A-4C each illustrate an exemplary system 400 comprising substrate 410, composite coating 420, and fluid 430 comprising foulant particles 440. In some embodiments, composite coating 420 comprises a first material and a second material selected such that a full-spectral Hamaker constant associated with composite coating 420 and fluid 430 is relatively low.

In operation, fluid 430 containing foulant particles 440 flows such that fluid 430 is in physical contact with composite coating 420 disposed on substrate 410. In some cases, since the full-spectral Hamaker constant associated with composite coating 420 and fluid 430 is relatively low, and therefore van der Waals forces between foulant particles 440 and composite coating 420 are relatively low, foulant particles 440 do not adhere to composite coating 420.

A composite coating described herein may be deposited on a substrate using any deposition method known in the art. Examples of suitable deposition methods include, but are not limited to, sputtering, electron beam evaporation, thermal evaporation, filtered cathodic vacuum arc (FCVA) deposition, chemical vapor deposition (CVD), pulsed laser deposition (PLD), atomic layer deposition (ALD), molecular beam epitaxy (MBE), cold spray, weld overlay, diffusion bonding, surface reaction (e.g., carburization, boronization, nitrogenation), reactive physical vapor deposition (PVD), reactive CVD, electron beam induced breakdown deposition, layer-by-layer deposition, chemical plating, electroplating, “pickling,” nitriding, spin coating, and melt coating. Other deposition methods may also be used. In certain embodiments, at least a portion of a composite coating described herein is deposited on a substrate using physical vapor deposition (PVD). In certain embodiments, a first material may be deposited on the substrate, and a second material may subsequently be deposited on the substrate. In some embodiments, a first material may be deposited on the substrate, and a second material may subsequently be deposited on the first material.

The substrate may be formed from any suitable material. For example, the substrate may comprise a metal, a metal alloy, a ceramic, and/or a polymer. In certain instances, the substrate comprises a metal and/or a metal alloy. Non-limiting examples of suitable metals include iron, nickel, zirconium, aluminum, titanium, and chromium. Non-limiting examples of suitable metal alloys include a zirconium alloy (e.g., Zircaloy-2, Zircaloy-4, ZIRLO, M5), an iron alloy (e.g., FeCrAl), an aluminum alloy, a chromium alloy, and stainless steel. In some embodiments, the substrate comprises a material associated with a relatively low full-spectral Hamaker constant. In some such embodiments, the substrate comprises (or, in some instances, consists of) fluorine-doped tin oxide (FTO), calcium fluoride (CaF₂), cryolite (Na₃AlF₆), fluorinated diamond-like carbon (F-DLC), amorphous carbon (a-C), zirconium nitride (ZrN), titanium carbide (TiC), and/or titanium nitride (TiN).

In some embodiments, the substrate comprises a single layer of a material. In certain instances, the substrate comprises a plurality of layers of one or more materials. In some such instances, the substrate comprises a first layer and a second layer disposed on the first layer. In certain cases, the first layer comprises a zirconium alloy (e.g., Zircaloy-2, Zircaloy-4, ZIRLO, M5), an iron alloy (e.g., FeCrAl), an aluminum alloy, a chromium alloy, and/or stainless steel. In certain cases, the second layer disposed on the first layer comprises ZrO₂, Fe₃O₄, CrO₂, and/or Al₂O₃. In some instances, a first layer of the substrate comprises cladding of a nuclear fuel rod, and a second layer of the substrate comprises an oxidation product of the cladding material. In certain instances, for example, a first layer of the substrate comprises a zirconium alloy (e.g., Zircaloy-2, Zircaloy-4, ZIRLO, M5), and a second layer of the substrate comprises zirconium oxide (ZrO₂).

In certain embodiments, one or more buffer layers may be positioned between the substrate and the composite coating. In certain instances, the one or more buffer layers positioned between the substrate and the composite coating may enhance adhesion of the composite coating to the substrate, minimize thermal expansion, and/or minimize lattice strain mismatch between the coating and the substrate. In certain instances, the one or more buffer layers may provide a sticky, oxide-free surface for deposition of the coating. A non-limiting example of a suitable material for the one or more buffer layers is titanium. According to one non-limiting embodiment, an article comprises a substrate, a buffer layer comprising titanium disposed on at least a portion of the substrate, and a composite coating comprising amorphous carbon (e.g., tetrahedral amorphous carbon) disposed on at least a portion of the buffer layer.

In some embodiments, a system comprises a fluid comprising one or more foulants. The fluid may be any suitable fluid (e.g., a liquid, a gas). Non-limiting examples of suitable fluids include liquid water, deuterated water, an alcohol (e.g., ethanol, methanol, isopropanol), glycerin, carbon dioxide (e.g., liquid CO₂, supercritical CO₂), liquid ammonia, and liquid nitrogen. In certain cases, the water is distilled and/or deionized water.

The fluid may have any suitable pH. In certain cases, the fluid has a pH of at least 6.0, at least 6.5, at least 6.6, at least 6.7, at least 6.8, at least 6.9, at least 7.0, at least 7.1, at least 7.2, at least 7.3, at least 7.4, at least 7.5, at least 7.6, at least 7.7, at least 7.8, at least 7.9, or at least 8.0. In some embodiments, the fluid has a pH in a range from 6.0 to 6.5, 6.0 to 7.0, 6.0 to 7.5, 6.0 to 8.0, 6.5 to 7.0, 6.5 to 7.5, 6.5 to 8.0, 7.0 to 7.5, 7.0 to 8.0, or 7.5 to 8.0. In some instances, a higher pH level may lead to a lower foulant deposition rate.

In some cases, composite coatings described herein may reduce and/or eliminate adhesion of one or more foulants to a coating surface. The one or more foulants may be any type of foulant. For example, the one or more foulants may comprise any metal, metalloid, semiconductor, or ceramic. In certain cases, at least one foulant is a corrosion product. Non-limiting examples of foulants include SiO₂, TiO₂, ZnO, stainless steel (e.g., SS304), Ni, Ag, Fe₂O₃, Fe₃O₄, a-FeOOH, NiO, ZrO₂, LiBO₂, Li2B₄O₇, NiFe₂O₄, FeCr₂O₄, Ni₂FeBO₅, CaCO₃, ZnO, B₂O₃, Fe₃BO₅, and Ni₃B₂O₆. In some embodiments, the one or more foulants comprise a non-stoichiometric nickel ferrite NiₓFe₃₋ₓO₄ , where 0 ≤ x ≤ 1. In certain cases, the one or more foulants comprise one or more radioisotopes. Examples of radioisotopes include, but are not limited to, ⁶⁰Co, ⁵⁴Mn, ⁶⁵Zn, ⁵⁸Co, ⁵⁹Fe, and ⁵¹Cr. The one or more foulants may have any shape. In some cases, one or more foulants are substantially spherical or substantially ellipsoidal. In some cases, one or more foulants are irregularly shaped. The one or more foulants may also have any size. In certain cases, the one or more foulants comprise particles having a diameter of about 1 µm or less, about 500 nm or less, about 200 nm or less, about 100 nm or less, about 50 nm or less, or about 10 nm or less. In some cases, the one or more foulants comprise particles having a diameter in a range from 10 nm to 50 nm, 10 nm to 100 nm, 10 nm to 200 nm, 10 nm to 500 nm, 10 nm to 1 µm, 50 nm to 100 nm, 50 nm to 200 nm, 50 nm to 500 nm, 50 nm to 1 µm, 100 nm to 200 nm, 100 nm to 500 nm, 100 nm to 1 µm, 200 nm to 500 nm, 200 nm to 1 µm, or 500 nm to 1 µm.

In some aspects, an article described herein is a nuclear fuel rod comprising a hollow cladding, a fissile or fertile fuel positioned within the hollow cladding, and a coating disposed on at least a portion of an outer surface of the hollow cladding. The fissile or fertile fuel may, in some embodiments, comprise uranium, plutonium, and/or thorium. Fissile fuel generally refers to a material capable of sustaining nuclear fission. Non-limiting examples of suitable materials for fissile fuel include uranium-235, uranium-233, plutonium-239, and plutonium-241. Fertile fuel generally refers to a material that can be converted to fissile material through neutron absorption and subsequent nuclei conversions. Non-limiting examples of suitable materials for fertile fuel include thorium-232, uranium-234, uranium-238, plutonium-238, and plutonium-240. The fissile or fertile fuel in the nuclear fuel rod may take any suitable form. In some embodiments, the fissile or fertile fuel is in the form of pellets, powder, and/or plates.

According to some embodiments, a nuclear reactor system comprises one or more fuel rods and a coolant in contact with at least one fuel rod. In some embodiments, at least one fuel rod comprises a hollow cladding comprising a metal and/or a metal alloy, a fissile or fertile fuel positioned within the hollow cladding, and a coating disposed on at least a portion of an outer surface of the hollow cladding. The coolant may be any suitable fluid. The coolant may have any suitable pH. In certain cases, the coolant has a pH of at least 6.0, at least 6.5, at least 6.6, at least 6.7, at least 6.8, at least 6.9, at least 7.0, at least 7.1, at least 7.1, at least 7.2, at least 7.3, at least 7.4, at least 7.5, at least 7.6, at least 7.7, at least 7.8, at least 7.9, or at least 8.0. In some embodiments, the coolant has a pH in a range from 6.0 to 6.5, 6.0 to 7.0, 6.0 to 7.5, 6.0 to 8.0, 6.5 to 7.0, 6.5 to 7.5, 6.5 to 8.0, 7.0 to 7.5, 7.0 to 8.0, or 7.5 to 8.0. In some instances, a higher pH level may lead to a lower foulant deposition rate.

In certain embodiments, the nuclear reactor system is a nuclear reactor (or a portion of a nuclear reactor). The nuclear reactor may be any type of nuclear reactor. Examples of suitable nuclear reactors include, but are not limited to, pressurized water reactors (PWRs), boiling water reactors (BWRs), light water reactors (LWRs), pressurized heavy water reactors, gas-cooled reactors, fast breeder reactors, small modular reactors, and pebble bed reactors. In some cases, the nuclear reactor is operated at a relatively high temperature. In certain cases, for example, one or more locations within the nuclear reactor (including, in some cases, a substrate upon which a coating described herein is deposited) reach a temperature of at least 250° C., at least 300° C., at least 315° C., at least 330° C., at least 350° C., at least 400° C., at least 500° C., at least 600° C., at least 700° C., at least 800° C., at least 900° C., at least 1000° C., at least 1100° C., at least 1200° C., at least 1300° C., at least 1400° C., at least 1500° C., at least 1600° C., at least 1700° C., at least 1800° C., at least 1900° C., at least 2000° C., at least 2100° C., at least 2200° C., or at least 2500° C. In some embodiments, one or more locations within the nuclear reactor (including, in some cases, a substrate upon which a coating described herein is deposited) reach a temperature in a range from 250° C. to 300° C., 250° C. to 315° C., 250° C. to 330° C., 250° C. to 350° C., 250° C. to 500° C., 250° C. to 1000° C., 250° C. to 1500° C., 250° C. to 2000° C., 250° C. to 2200° C., 250° C. to 2500° C., 300° C. to 330° C., 300° C. to 350° C., 300° C. to 500° C., 300° C. to 1000° C., 300° C. to 1500° C., 300° C. to 2000° C., 300° C. to 2200° C., 300° C. to 2500° C., 315° C. to 330° C., 315° C. to 350° C., 315° C. to 500° C., 315° C. to 1000° C., 315° C. to 1500° C., 315° C. to 2000° C., 315° C. to 2200° C., 315° C. to 2500° C., 330° C. to 350° C., 330° C. to 500° C., 330° C. to 1000° C., 330° C. to 1500° C., 330° C. to 2000° C., 330° C. to 2200° C., 330° C. to 2500° C., 350° C. to 500° C., 350° C. to 1000° C., 350° C. to 1500° C., 350° C. to 2000° C., 350° C. to 2200° C., 350° C. to 2500° C., 500° C. to 1000° C., 500° C. to 1500° C., 500° C. to 2000° C., 500° C. to 2200° C., 500° C. to 2500° C., 1000° C. to 2000° C., 1000° C. to 2200° C., 1000° C. to 2500° C., 1500° C. to 2000° C., 1500° C. to 2200° C., 1500° C. to 2500° C., 2000° C. to 2200° C., or 2000° C. to 2500° C.

In some embodiments, the nuclear reactor is operated at a relatively high pressure. In certain instances, a coolant flowing through the nuclear reactor has a pressure of at least 1000 pounds per square inch (PSI), at least 1500 PSI, at least 2000 PSI, at least 2250 PSI, at least 2500 PSI, or at least 3000 PSI. In some cases, a coolant flowing through the nuclear reactor has a pressure in a range from 1000 PSI to 2000 PSI, 1000 PSI to 2250 PSI, 1000 PSI to 2500 PSI, 1000 PSI to 3000 PSI, 2000 PSI to 2500 PSI, 2000 PSI to 3000 PSI, 2250 PSI to 2500 PSI, 2250 PSI to 3000 PSI, or 2500 PSI to 3000 PSI.

In some embodiments, materials of a composite coating and/or a substrate are resistant to radiation (i.e., they retain their properties upon exposure to radiation in a nuclear reactor). In certain cases, for example, materials of a composite coating and/or a substrate are resistant to radiolysis under operating conditions of a nuclear reactor. In some instances, materials of a composite coating and/or a substrate are substantially resistant to corrosion.

Some aspects are directed to a method. In some embodiments, the method comprises depositing a first material of a composite coating in a first region on a substrate. In some embodiments, the method comprises depositing a second material of a composite coating in a second region on the substrate. The first and second materials may be independently deposited by any deposition method known in the art. Non-limiting examples of suitable deposition methods include sputtering, electron beam evaporation, and thermal evaporation, filtered cathodic vacuum arc (FCVA) deposition, chemical vapor deposition (CVD), pulsed laser deposition (PLD), atomic layer deposition (ALD), molecular beam epitaxy (MBE), cold spray, weld overlay, diffusion bonding, surface reaction (e.g., carburization, boronization, nitrogenation), reactive PVD, reactive CVD, electron beam induced breakdown deposition, layer-by-layer deposition, chemical plating, electroplating, “pickling,” nitriding, spin coating, and melt coating. Other deposition methods may also be used. In some embodiments, the first material and/or the second material of the composite coating are deposited via PVD.

In some embodiments, the composite coating is configured to be exposed to a fluid comprising one or more foulants during use. In certain embodiments, the first material is associated with a first set of optical properties (e.g., refractive indices, dielectric response values) over a range of wavelengths. In certain embodiments, the second material is associated with a second set of optical properties (e.g., refractive indices, dielectric response values) over the same range of wavelengths. In certain embodiments, the fluid is associated with a third set of optical properties over the same range of wavelengths. In certain embodiments, a root-mean-square deviation of a weighted average of the first and second sets of refractive indices from the third set of refractive indices is relatively low (e.g., about 0.5 or less). In some embodiments, a full-spectral Hamaker constant associated with the composite coating and the fluid is relatively low.

### EXAMPLE 1

In this Example, six potential materials for multi-foulant-resistant coatings were tested. The coating materials were selected based on the hypothesis that matching the refractive index spectrum of a coating to its surrounding fluid minimizes van der Waals (vdW) forces between the coating and any foulant immersed in the fluid, and thus minimizes the adhesion of all foulants entrained in the fluid. It was found that amorphous, 2% fluorine-doped tin oxide (FTO), CaF₂, and Na₃AlF₆, which all nearly match the refractive index of water, successfully resisted adhesion of six diverse foulant materials in aqueous atomic force microscopy (AFM) measurements. First-principle calculations of Hamaker constants and refractive indices of six foulants on six coatings in water correlated well with direct measurements of adhesion by AFM force spectroscopy.

### Materials and Methods

### Material Selection, Sourcing, and Characterization

Six different foulants having diverse visible-range (632 nm) refractive indices - SiO₂, TiO₂, ZnO, stainless steel (SS304), Ni, and Ag (a well-known material that does not oxidize) - were used in this Example. The six coating materials investigated - 2% fluorine-doped tin oxide (FTO), CaF₂, Na₃AlF₆, indium tin oxide (ITO), SiO₂, and bare Si wafers - included candidate coating materials selected based on their low visible-range refractive indices as well as materials with relatively high refractive indices for clear comparison. The coatings were deposited onto Si wafers using physical vapor deposition by PVD Products, Inc. on unheated substrates, with the exception of thin films of FTO and ITO, which were purchased as coated glass slides from Sigma-Aldrich.

### Crystal Structure Analysis

Grazing incidence X-ray diffraction (GIXD) patterns were recorded to confirm the crystallographic phase of each as-deposited coating. These were obtained at grazing incidence (θ = 0.5°) on a Rigaku SmartLab X-ray diffractometer through parallel-beam geometries operating at 45 kV and 200 mA.

### Surface Chemical Analysis

X-ray photoelectron spectroscopy (XPS) (PHI VersaProbe III Scanning XPS Microprobe, Physical Electronics, Chanhassen, MN, USA) was performed to investigate the chemical composition of each sample surface prior to atomic force microscopy-based force spectroscopy (AFM-FS) experiments. Each sample was first sputtered with argon plasma for 10 minutes to remove the surface oxide. A monochromatic Al Ka X-ray source (1486.6 eV) was operated at a pass energy of 187.85 eV, a step size of 0.1 eV over a measurement area of 10 µm × 10 µm, and a takeoff angle of 45°. Survey spectra were taken from 100 to 1100 eV to identify the existence of different elements. High-resolution spectra of existing species were taken at a pass energy of 23.5 eV. The binding energy scale was referenced via a constant offset to the C-C signal at 284.8 eV. Quantitative analysis was carried out with CasaXPS 2.3.15 (http://www.casaxps.com/) to deconvolute any overlapping XPS peaks.

### Coating Thickness and Roughness Measurements

Cross-sectional analysis of each coating was performed after AFM-FS measurements using a gallium focused ion beam (FIB) (FEI Helios Nanolab 600 Dual Beam System). A 1 µm thick Pt protective layer was deposited on the surfaces to prevent FIB damage to the coatings. To provide electrical conductivity for imaging, the SiO₂ sample was coated with approximately 10 nanometers of gold. Coating surface roughnesses were also analyzed using AFM in scanning mode.

### Refractive Index Spectrum Measurement

The refractive indices of the coatings were deduced from white light analysis (Filmmetrics, F20, San Diego, USA) working in the wavelength range of 190-1000 nm (6.5-1.2 eV) using a spot size of approximately 7 mm. Background and reference spectra were taken on a Si polished wafer. Data analysis was conducted using FILMeasure software (Filmmetrics, F20, San Diego, USA). n and k values from the literature were fitted using the fixed input thickness parameters from FIB cross sectional analyses.

### AFM Probe Preparation

Rectangular silicon nitride (Si₃N₄) lithographically fashioned cantilevers from Nanosensors (TL-FM series) were used. For the functionalization of AFM-FS probes, 4 µm diameter microspheres were externally sourced from Cospheric, Inc. and confirmed in a scanning electron microscope (SEM) for correct diameter and sphericity. Spheres had to be at least 95% spherical to qualify for the tests, as defined by the minor and major axes of the normally elliptical geometry of any imperfect sphere. Attachment of the microspheres was carried out by Novascan, Inc. using a pick-and-place nanomanipulator to position the microsphere at the tip of the cantilever and a thermal adhesive to affix it. The foulant microspheres used in this Example - Ni, Ag, SiO₂, TiO₂, 304 stainless steel (SS304), and ZnO - were obtained from Cospheric, Inc.

### AFM-FS Measurements

All AFM measurements were performed in force-distance (FD) ramp mode using a NanoMagnetics, Inc. ezAFM AQUA. The ezAFM AQUA was inserted into a custom-built environmental chamber, including an argon sputtering gun system, used to pre-clean all coatings to avoid spurious measurements of airborne contaminants. AFM-FS measurements were carried out by making contact between each representative foulant particle and coating pair. After contact was made, the cantilever was pulled away from the surface. The maximum downward force was kept constant at 100 nN by means of a deflection trigger mode. The adhesion measurements were carried out in a droplet of room temperature, deionized water (>15 MΩ). The probe was moved at a constant speed of 100 nm/s and to a total amplitude of 200 nm, with a sphere-surface contact time of approximately 100 ms per measurement. Measurements were performed on a point-by-point basis, with at least 10 µm separation between points, with measurement locations chosen at random to cover most of the 10 mm × 10 mm sample area. At least 50 points were measured on each sample.

Surface asperities, changes in roughness, thermal noise, and sample back-reflections of the laser beam contributed to uncertainty in the signal, resulting in large error bars. This is typical of AFM-FS measurements, where forces on the order of hundreds of piconewtons (pN) of signal compete with all sources of electronic, optical, and vibrational noise. Measurements were conducted with multiple randomized runs of each foulant-coating combination, with multiple, redundant tips and coatings to ensure that anomalies in any single material or method did not interfere with the dataset.

### Adhesive Force Calculation from AFM-FS Data

A ramp performed over a hard surface (here, a polished SiC sample) was used to determine the sensitivity S of the specific probe alignment and laser power. The piezo accuracy was verified by a tapping mode scan of a height calibration sample (Ted Pella, Inc., HS series). A reference cantilever method, with a Bruker CLFC series calibration probe, was used to determine the stiffness k of the probes. This method was chosen because its accuracy is unaffected by the presence of the microsphere on the test cantilever. Once the above calibrations were complete, the output of the quadrant photodiode ΔV in the pull-off section of an FD curve was converted to a force by the following equation:

$${F}_{a d h} = \left(Δ V\right) S k$$

### First-Principle Calculation of Hamaker Constants

The adhesion of foulant-coating pairs in this Example was calculated using a combination of first-principle atomistic calculations on a unit cell scale to obtain optical properties and continuum Hamaker calculations to obtain a vdW force applied on a micrometer scale. This hybrid approach permitted fast calculation times and the rapid computational evaluation of fouling-resistant materials that were less explored in the literature. The VASP (Vienna Abinitio Simulation Package) density functional theory (DFT) software was used to find frequency-dependent dielectric response ε″(ω) for each studied material, using the optical functionality package within VASP. This dielectric response was converted to ∈(iξ) using Equation 6. The ∈(iξ) of water was calculated using known optical properties. Subsequently, the Hamaker constant for each foulant-coating pair was calculated using a finite series expansion of Equation 2 with the limits given in Equation 9.

Using DFT, it was found empirically that a 5-parameter expression, based on a slightly altered formulation that removes the 1/ξ term for considerations of physicality, provided an excellent (R² is approximately 0.999) fit to ∈(iξ) for all the studied materials:

$$∈ \left(i ξ\right) \approx 1 + \frac{A}{1 + B ξ + C {ξ}^{2}} + \frac{D}{1 + E {ξ}^{2}}$$

where A-E are constants found by a least-squares fit to the DFT dielectric function results of each material. Constants A-E are summarized in Table 1 for the studied materials. Neglecting IR oscillations for a coarse comparison, A + D ∝ n² where n is the refractive index of the material, and it is seen that the foulant-resistant materials have a lower A + D.

TABLE 1

| Material | A (eV²) | B(eV) | C (ul) | D (eV²) | E (ul) | A + D (eV²) |
|---|---|---|---|---|---|---|
| Si | 3.405 | 0.0007 | 0.0396 | 6.018 | 0.0718 | 9.423 |
| Na₃AlF₆ | 0.8325 | 0.0215 | 0.0032 | 0.8787 | 56.22 | 1.7112 |
| CaF₂ | 0.2318 | 0.0038 | 0.0015 | 0.6755 | 0.0099 | 0.9073 |
| SiO₂ | 1.387 | 0.0151 | 0.0052 | 0.4307 | 9.546 | 1.8177 |
| c-FTO | 1.448 | 0.0629 | 0.012 | 1.862 | 0.0694 | 3.31 |
| ZrO₂ | 3.694 | 0.0175 | 0.017 | 0.5852 | 0.0017 | 4.2792 |

A unit cell of each material of interest was simulated in VASP. Each cell was constructed using literature values for lattice parameters. Following a geometric relaxation with atom position and cell volume optimization, the dielectric function was calculated using the LOPTICS flag. Projector augmented wave (PAW) Perdew-Burke-Emzerhof (PBE) pseudo-potentials were used. A KPOINTS consistency check was performed for each material, with the number of K-points satisfying K > 50/a where a is the lattice spacing in Angstroms. NEDOS was set to 2000 and NBANDS was greater than 2N₀, where N₀ corresponds to the bands resulting from the relaxation step.

### Results and Discussion

In this Example, four coatings predicted to be multi-foulant-resistant (SiO₂, amorphous FTO (a-FTO), CaF2, and Na3AlF6) were investigated, along with materials with a range of refractive indices (ITO, pure Si, crystalline FTO (c-FTO), and borosilicate glass). A range of metals (with and without passive oxide layers) and oxides (ranging from low to high refractive index) were used as colloidal probes, and most were commonly found foulants in nuclear and geothermal systems. These were Ni, Ag, SiO2, SS304, TiO₂, and ZnO.

The interaction forces between each of the six coatings, plus uncoated Si and glass substrates, and each of the six foulant particles were measured using an AFM colloidal probe in a droplet of deionized water (>15 MΩ) to avoid ionic screening effects and to match the water properties used in power plants. The roughness, chemistry, crystal phases, and refractive index spectrum of the coatings were studied using atomic force microscopy (AFM), X-ray photoelectron spectroscopy (XPS), grazing incidence angle X-ray diffraction (GIXD), and white light reflectometry, respectively, while coating thicknesses were obtained using focused ion beam (FIB) cross sectioning corroborated by white light reflectometry model fits. Vienna Ab-initio Simulation Package (VASP) was used to perform first-principle calculations of the full-spectrum ε″(ω) of the same six candidate coatings, followed by a numerical solution of Equations 1 and 2 to obtain F_{vdW}. The experimental and computational results demonstrate that amorphous, 2% fluorine-doped tin oxide (FTO), CaF₂, and Na₃AlF₆, which all nearly match the refractive index of water, successfully resisted adhesion of six diverse foulant materials.

### Characteristics of the Surfaces

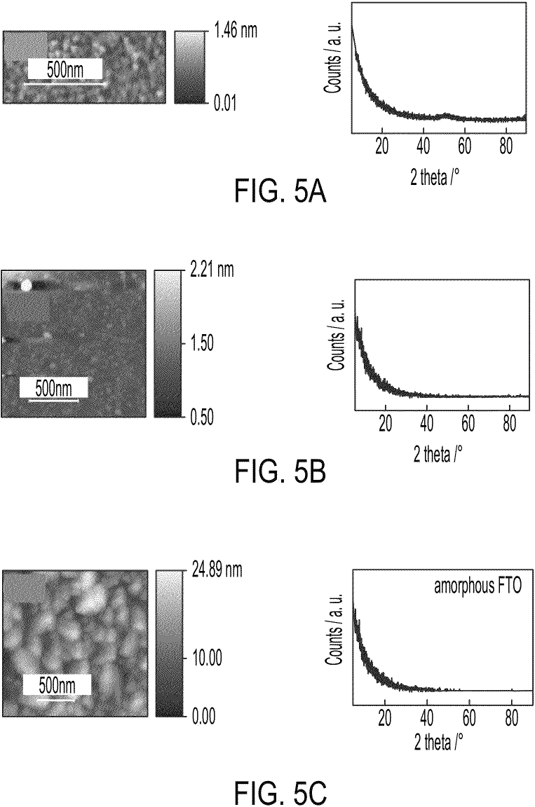

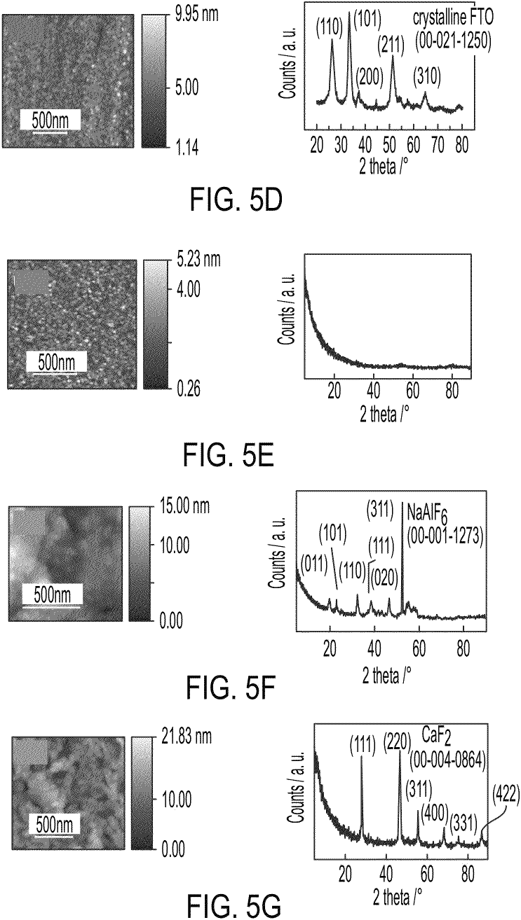

FIGS. 5A-5G show the AFM-measured surface roughness and GIXD crystallographic characterization of representative areas of the coatings studied in this Example. GIXD results show that CaF₂ and Na₃AlF₆ were crystalline, while FTO made at room temperature, ITO, and SiO₂, were amorphous. FTO purchased from an outside supplier was measured by GIXD to be crystalline. The FTO samples were therefore referred to as a-FTO and c-FTO for amorphous and crystalline, respectively. The bare Si wafer was known to be crystalline. XRD patterns of CaF₂ were consistent with the reported data in PDB file JPDC-00-004-0864, indicating a cubic crystalline structure. The XRD pattern of Na₃AlF₆ matched PDB file JPDC-00-001-1273, indicating a monoclinic structure. Also in the Na₃AlF₆ pattern, the diffraction from the Si substrate at 52° was clear. More importantly, the FTO coating fabricated through PVD, using substrate heating, had a tetragonal structure matching SnO₂, as in PDB file JPDC-00-021-1250, while that manufactured with no substrate heating was amorphous.

FIGS. 5A-5G indicate that the initial surface roughness values of the 6 different coatings were comparable and were relatively smooth. The root mean square (RMS) value of the coatings varied between 3 nm and 16 nm.

Table 2 shows the results from contact angle and surface roughness measurements. The surface roughness values were used in translating AFM-measured surface forces to Hamaker constants, using the surface roughnesses as l 1in Equations 1-2 and 7-8. Contact angle measurements were taken to ensure that contamination did not noticeably exist on surfaces by comparison to literature data.

TABLE 2

| Material | Contact Angle (deg.) | Surface Roughness, RMS (nm) |
|---|---|---|
| Si | 60.8 | 0.273 |
| Na₃AlF₆ | 19.16 | 15.528 |
| c-FTO | 77.17 | 3.363 |
| a-FTO | 78.51 | 14.874 |
| CaF₂ | 40.11 | 9.619 |
| ITO | 105.53 | 3.086 |
| SiO₂ | 97.54 | 0.512 |

ITO and SiO₂ were confirmed to be hydrophobic, while Si, Na₃AlF₆, c-FTO, a-FTO, and CaF₂ were hydrophilic. The contact angle strongly depends on surface preparation, which in the case of this Example was PVD deposition at room temperature.

### AFM-FS Measurements of Coating-Foulant Adhesion in Water

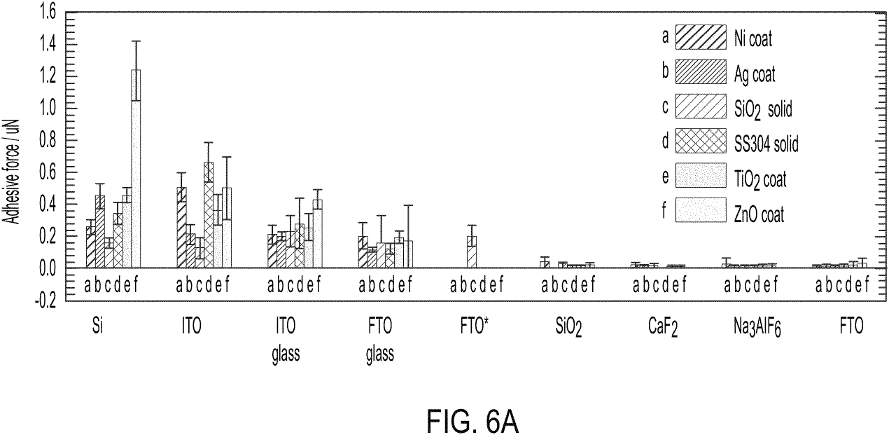

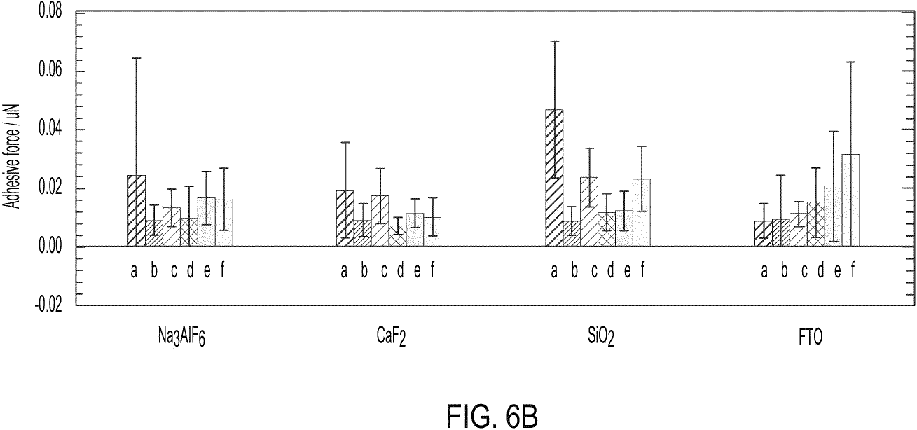

FIGS. 6A-6B show the results of AFM-FS measurements between six different foulants (Ni, Ag, SiO₂, SS304, TiO₂, and ZnO) and six different coatings (ITO, crystalline FTO (labeled as “FTO*” in FIG. 6A), SiO₂, CaF₂, Na₃AlF₆, and amorphous FTO (labeled as “FTO” in FIG. 6A)), plus uncoated Si and glass (labeled as “FTO glass” and “ITO glass” in FIG. 6A), recorded in a droplet of deionized water at 25° C. In particular, FIG. 4A shows the adhesive force for each foulant-coating combination. Materials designated “FTO glass” and “ITO glass” were uncoated glass substrates of the same material as used for the coated samples, for the purposes of comparing the specific adhesion influence of the FTO/ITO coatings. FIG. 6B shows the four lowest adhesive force materials re-plotted with a smaller y-axis range for clarity. Many different trends can be observed in FIGS. 6A-6B. First, uniformly 20-50x lower adhesion values of cryolite, fluorite, quartz, and amorphous FTO were observed, in comparison to uncoated samples. Second, in all materials with low refractive indices, the measured adhesive force was largely independent of the foulant, demonstrating the aforementioned “multi-foulant-resistant” behavior. This suggests that no matter which foulant(s) will be encountered in an energy-producing system, these coatings or those similarly designed will resist fouling and deposition. Other notable observations include that uncoated Si exhibited the highest adhesive force, and was definitively not multi-foulant resistant.

With only one exception (Ni on SiO₂), the slicker materials exhibited no statistically significant variation when testing the six different foulants. Under the test conditions, passive oxides likely existed on the Ni and SS304 test spheres. However, these oxides were typically just a few nanometers thick, while vdW forces still act upon material thicknesses roughly 10 times this thickness. Sticky surfaces, because there is no match between refractive indices of the coating and the water, do not exhibit multi-foulant-resistant behavior, nor should they according to the TWA equation. This represents another key false-negative discrimination test, because the theory predicts that only slick surfaces will be multi-foulant-resistant, and sticky materials will not. Due to the requirement for keeping consistent measurement parameters (such as laser power and alignment) between multiple samples and probes, and the need to cover large geometric areas on each sample, it was not feasible to attempt further error bar reduction. The various sources of error in this measurement were mainly statistical in nature, as the roughnesses of the as-deposited coatings were kept low due to their glass or Si wafer substrates, and the size & spheroidicity of the functionalized SiO₂ microspheres coated with potential foulants were uniform. This rendered a simple reporting of means and standard deviations to be a statistically accurate method of representing the data.

### Analysis of Refractive Indices and Hamaker Constants

The refractive index and the Hamaker constant were hypothesized to directly relate to adhesion. It was expected based on the literature refractive indices that Na₃AlF₆ should exhibit the lowest adhesive force, while uncoated Si and glass should exhibit the highest adhesive forces. This conclusion held true within the error bars of the data. The AFM-FS measurements indicated that the room-temperature, PVD-manufactured FTO coating had the lowest average adhesive force, which was unexpected. It was determined by XRD that the FTO coating as formed by PVD was amorphous, not crystalline. A crystalline FTO sample was sourced for comparison and showed a higher adhesive force, as expected from its higher refractive index.

Optical constants of the coatings were analyzed through white light reflectometry. The data were deduced using fixed thicknesses, obtained from FIB cross section image analysis, and compared to n and k values from the literature.

TABLE 3

| Material | d(nm) | Experimental n₆₃₂ | DFT n₆₃₂ | Literature n₆₃₂ | A_{Ham} (zJ) |
|---|---|---|---|---|---|
| Si | 3000 | 3.86 | 4.418 | 3.9 | 24.07 |
| Na₃AlF₆ | 300 | 1.43 | 1.392 | 1.34 | 0.71 |
| c-FTO | 300 | 2.18 | 1.98 | 2.01 | 17.87 |
| a-FTO | 900 | 1.41 | | | |
| CaF₂ | 900 | 1.43 | 1.552 | 1.43 | 7.31 |
| ITO | 30 | 1.85 | 2.05 | 1.88 | 18.45 |
| SiO₂ | 700 | 1.45 | 1.609 | 1.448 | 7.65 |

Table 3 compares the refractive indices found in this Example and their published literature values. Notably, there was a large difference between the experimental and published refractive indices for a-FTO compared to literature values for c-FTO, suggesting that the coating chemistry and/or structure did not match the sputtering target used to create it. This highlights the importance of the substrate temperature in forming a crystalline or amorphous film, because the XRD analyses confirmed that an amorphous FTO film was grown from a crystalline FTO target. FIG. 5 shows plots of the DFT-calculated visible (632 nm) refractive indices and Hamaker constants (zJ) for each of the six coatings. Broad agreement between the DFT-calculated refractive indices and experimentally-measured Hamaker constants helped to confirm the hypothesis that refractive indices could be used to choose or design multi-foulant-resistant coatings.

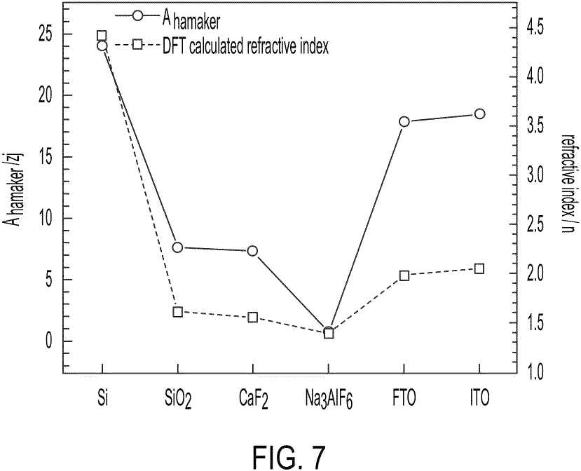

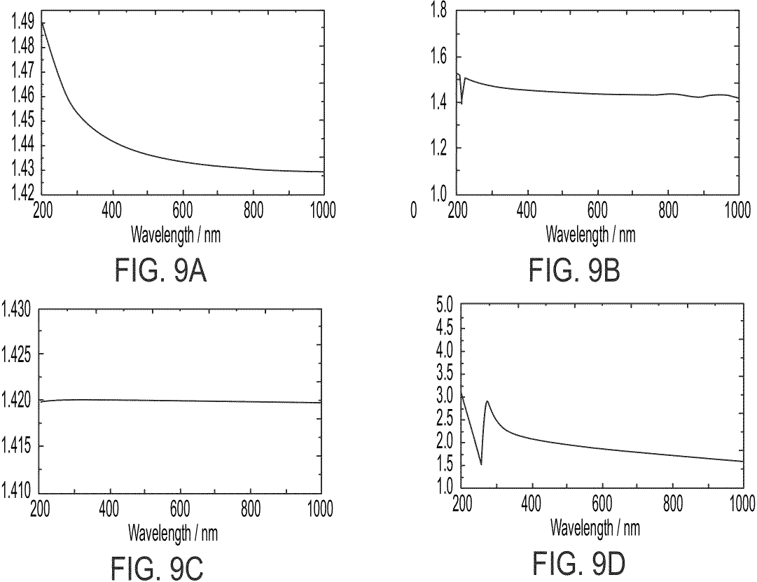

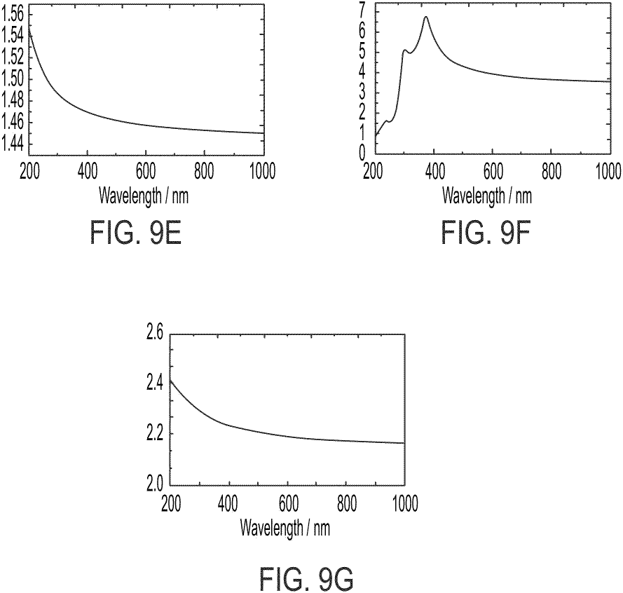

The DFT-calculated visible and ultraviolet (UV) refractive indices of the materials under consideration in comparison with their adhesive forces averaged over all six foulants are shown in FIGS. 7 8. The full white light reflectometry spectra for CaF₂, Na₃AlF₆, amorphous FTO, ITO, SiO₂, Si, and crystalline FTO are shown in FIGS. 9A-9G. The thicknesses obtained from FIB cross-sectional analyses were used as input parameters.

From optical data analysis and the full white light reflectometry spectra shown in FIGS. 9A-9G, it was clear that the adhesive force increased as the refractive index increased in the visible range. In contrast with the coatings, the refractive index of uncoated Si did not follow the adhesive force in the UV range, which confirmed the TWA approximation. A comparison of the results and the literature also yielded interesting insights. The refractive indices of Si, CaF₂, SiO₂, and ITO found in this Example were consistent with the reported literature values. The refractive index of the amorphous FTO initially grown in this Example was found to be 1.41, while it was reported that crystalline FTO had an n value about 1.9. In FIG. 5C, the GIXD pattern of FTO indicates that the FTO coating was amorphous, which could have significant impact on the refractive index. The ITO used in this Example was also found to be amorphous by GIXD, although the n value of ITO obtained in this Example was consistent with the literature. The synthesis technique (PVD) and dopant amount may affect the conductivity of FTO and, thus, optical constants.

The reported refractive index for Na₃AlF₆ was 1.44, while the measured value from white light spectroscopy was 1.49. The Na₃AlF₆ coating was crystalline as shown in FIG. 5F, though a Si substrate peak was also observed. The difference between literature data and experimental data may originate from the inhomogeneity of the film. In this Example, a smooth, bare Si wafer was used as a substrate for potentially multi-foulant-resistant coating depositions and was also measured in uncoated form to validate effectiveness of the coating layer. As expected, the uncoated wafer showed the highest adhesive force and also had the highest refractive index. However, the refractive index measured in this Example, 3.86, was slightly lower than literature value of 3.97.

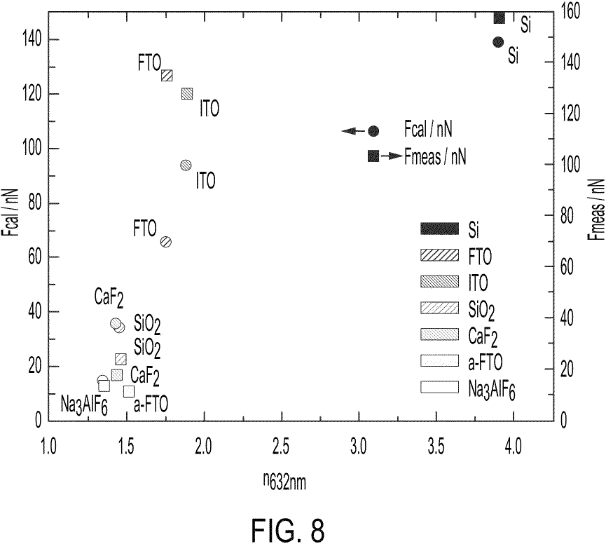

FIG. 8 shows plots of Hamaker-calculated adhesion forces (represented as circles) and experimentally-measured adhesion forces (represented as squares) as functions of the DFT-calculated visible refractive indices of the 7 coatings that were tested with AFM-FS in this Example (Si, a-FTO, c-FTO, ITO, SiO₂, CaF₂, Na₃AlF₆). Among all surfaces tested, Si had the highest Hamaker constant and highest refractive index, while the Hamaker constant and refractive index of Na₃AlF₆ were the lowest. CaF₂ and SiO₂ had closer Hamaker constants and refractive indices. The Hamaker constant and refractive indices of FTO and ITO were higher than CaF₂ and SiO₂, though it should be noted that DFT was used to calculate Hamaker constants of only the crystalline phases of all materials. The calculated and measured forces showed the same trends uniformly - increasing refractive index led to increased force (both calculated and measured) - giving confirmation that a low refractive index is indicative of fouling resistance. The results from the DFT calculation confirmed the hypothesis that the lower refractive index coatings will exhibit lower adhesive forces to foulants.

### Conclusion

This Example hypothesized and demonstrated a multi-foulant-resistant coating design principle, which assumed that vdW forces dominate attractions between colloidal particles and surfaces. A strong, quantitative correlation was shown between DFT-calculated and experimentally-measured adhesion forces for the multi-foulant-resistant materials, demonstrating that, while vdW forces are not the only surface forces acting to initiate fouling, they are a strong predictor of anti-fouling coatings. Equally important was the proposed and demonstrated multi-foulant-resistant feature of this approach, shown here to be valid for both metallic and non-metallic foulants. This design principle, when combined with additional, system-specific constraints (such as low neutron absorption cross section in nuclear power plants or H₂S corrosion resistance in geothermal systems), represents a useful tool to reduce or eliminate fouling as a scourge to large-scale, carbon-free energy production.

### Example 2

In this Example, flow loop tests were conducted in an internally heated test flow loop (IHTFP). These flow loop tests allowed fouling resistance to be studied in a reactor-like environment, under not only the high temperature and high pressure conditions, but also the heat flux and water flow conditions, of a PWR.

### Internally Heated Test Flow Loop (IHTFP)

### Overview

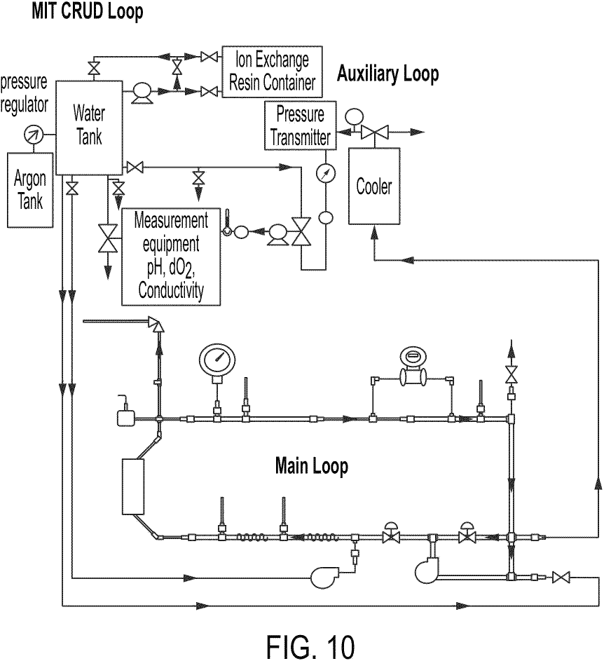

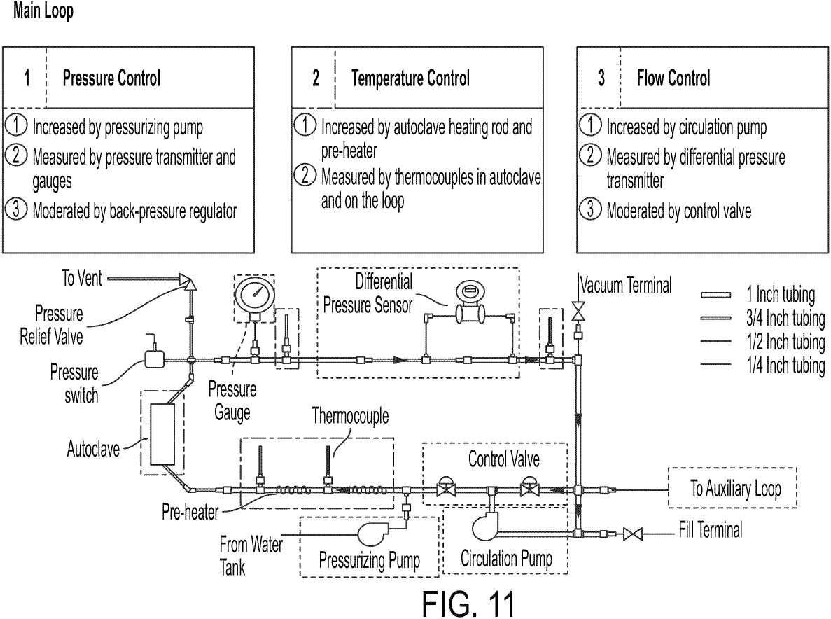

The flow loop included: (1) a main loop under PWR-like conditions; and (2) an auxiliary loop at room temperature and under slightly pressurized conditions to control chemistry within the flow loop. Schematic diagrams of the main and auxiliary loops of the IHTFP are shown in FIG. 10. FIG. 11 is a schematic diagram providing additional details regarding the IHTFP main loop. In order to study foulant deposition (i.e., crud growth), crud nanoparticles were deliberately introduced into the water flowing through the flow loop.

Samples for the flow loop test were thin rings designed to be representative of fuel rod cladding diameter. The rings were press-fit onto an electrically heated rod in the IHTFP main loop, which created a heat flux similar to that expected from nuclear fuel. A reciprocating piston pump pressurized the water in the main loop to 15.5 MPa, and an adjustable pressure relief valve maintained the main loop at a configurable pressure setting. A separate centrifugal circulating pump kept the water within the main loop flowing at a desired flow velocity to mimic the water flow around a fuel rod in a reactor. A set of electric tape heaters, along with the rod heater, raised and maintained the water temperature above 300° C. A 30 L fill tank, which was kept at atmospheric pressure in the auxiliary loop, supplied water for the main loop, with water from the fill tank being slowly exchanged into the main loop through the pressurizing pump and relief valve. The water in the fill tank included Fe₃O₄ and NiO nanoparticles, and a mixer in the fill tank kept the nanoparticles suspended in solution.

The IHTFP was monitored by a custom Visual Basic (VB) routine that handled actions such as turning pumps on and off and logging chemistry, flow, and pressure measurements. Heater control and pressure control were set manually using their dedicated controllers. A differential pressure sensor and a pneumatic adjustable valve were used to maintain a desired flow velocity in the main loop. The circulating pump ran at a constant speed, while the pneumatic valve was throttled to reduce water flow as necessary. The pressurizing pump operated continuously, slowly adding in water to the main loop from the fill tank, while the excess pressurized water was released back into the fill tank. This continued flow allowed the larger volume of the fill tank, kept at atmospheric pressure in the auxiliary loop, to stabilize the chemistry within the relatively small volume of the main loop.

A set of auxiliary pumps and equipment in the auxiliary loop adjusted and monitored the IHTFP water conditions. These low-duty centrifugal pumps had a minimal pressure gradient and operated at near atmospheric pressure, circulating water through the fill tank. The chemistry sensors included conductivity, dissolved oxygen, and pH sensors. These sensors could sample the pressure regulator backflow or the fill tank, where typically the latter was used as it provided a higher and more stable flow rate. The backflow was returned to the fill tank, and the fill tank chemistry was measured over time. Additionally, during some of the tests run (e.g., the Gen-II and Gen-III material measurements), a hydrogen generator was used to control hydrogen in the main loop to match PWR conditions. This enabled some coating materials to remain stable in the high temperature water, thus ensuring their continued crud resistance.

The pH was controlled by adjusting the Li and B concentrations using lithium hydroxide (LiOH) and boric acid. The pH was measured continuously, and it was typically stable enough to not require adjustment during a test run. The water chemistry in the main loop followed EPRI guidelines, and the pH at autoclave temperature was slightly above 7.0.

The IHTFP main loop conditions, along with representative PWR operating conditions, are shown in Table 4.

TABLE 4

| | | |
|---|---|---|
| | PWR | Main Loop |
| Pressure | 15.5 MPa | 15.5 MPa |
| Temperature | 287-324° C. | 320° C. |
| Reynolds No. | 5 x 10⁵ | 1.62 x 10⁵ |
| Mass Flux | 3500 kg/m²s | 1920 kg/m²s |
| Fe₃O₄, NiO | 0.01 - 0.1 ppm | 10 - 100 ppm |

### Flow Loop Tests

In the flow loop tests, samples were press fit onto the heater rod and installed in the main IHTFP loop. Next, crud representative nanoparticles (e.g., Fe₃O₄, NiO nanoparticles) were mixed into the fill tank, and the solution was pumped into the main loop. The main loop was brought to setpoint pressure, temperature, heat flux, and water flow velocity. This was maintained for one to two weeks, after which the main loop was cooled down and depressurized, and the heater rod was removed. The sample rings were cut from the heater rod using a Dremel tool. In some cases, a sample ring was scanned in a laser scattering apparatus. In some cases, a sample ring was further cut into strips with sheet metal shears. The strips were then analyzed in a scanning electron microscope (SEM) at high magnification, and elemental contrast in the SEM image was used to determine crud area coverage on the coated surface of the ring compared to the uncoated surface of the ring. A crud area coverage ratio was thus determined through image analysis.

### Samples

The IHTFP used ring-shaped samples having a height of 12.5 mm, an inner diameter of 17.35 mm, and a wall thickness of 0.365 mm. These dimensions were designed to be representative of fuel rod cladding diameter. The sample rings were made from reactor-grade zircaloy rod stock provided by Westinghouse. Each sample ring was coated with a material (e.g., a fouling resistant layer) via physical vapor deposition (PVD) on one side while the other side was left uncoated to provide a built-in control surface. PVD was an attractive choice due to its relative simplicity, robustness (e.g., not requiring a clean room), wide variety of usable materials, and lack of use of hazardous liquids or gases (and very few hazardous solids).

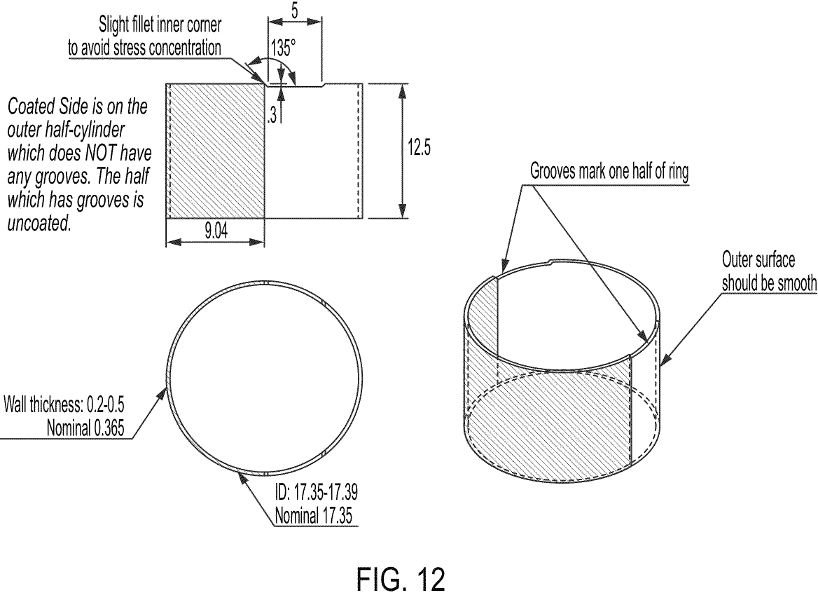

To facilitate identification of the coated and uncoated sides, each sample ring contained two asymmetric identification grooves that were used to mark the coated and uncoated surface edges. The grooves were machined into the ring and were designed to maintain most of the mechanical stability of the rings to allow them to withstand the press fit procedure. The coated side was on the half-cylinder that did not have any grooves, while the uncoated side was on the half-cylinder that did have grooves. Mechanical drawings of an exemplary sample ring having asymmetric grooves are shown in FIG. 12.

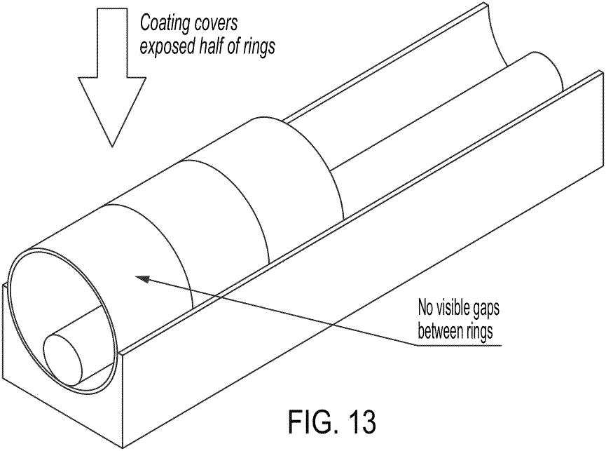

In some cases, a cylindrical mask holder covering the back surface of the ring was used during PVD to ensure a clear distinction between coated and uncoated sides of the ring. A schematic illustration of the mask holder is shown in FIG. 13. It was observed that without this mask, a thin but still substantial (e.g., 10% of nominal thickness) coating would be deposited on the rear half of the ring despite not being within a direct line of sight of the source.

Finally, a cleaning procedure that removed all organic residues left after machining the ring was performed to ensure a consistent adhesion of the coating layer onto the ring and prevent delamination of the coating layer.

### Results

### Gen-I Coating Materials

Initially, 9 materials selected based on industrially relevant properties were studied. These 9 materials, which were referred to as “Gen-I″ materials, were: TiN, TiC, TiO₂, TiB₂, ZrN, ZrC, ZrO₂, MgO, and Al₂O₃. The Gen-I materials and their refractive indices at 210 nm and 632 nm are shown in Table 5.

TABLE 5

| Material | n (210 nm) | n (632 nm) |
|---|---|---|
| ZrO₂ | 2.9 | 2.2 |
| ZrN | 2.6 | 2.2 |
| ZrC | 2.5 | 1.8 |
| TiO₂ | 0.5 | 2.8 |
| TiC | 1.8 | 3.7 |
| TiN | 1.77 | 1.74 |
| TiB₂ | 1.51 | 1.5 |
| Al₂O₃ | 1.82 | 1.77 |
| MgO | 1.77 | 1.73 |

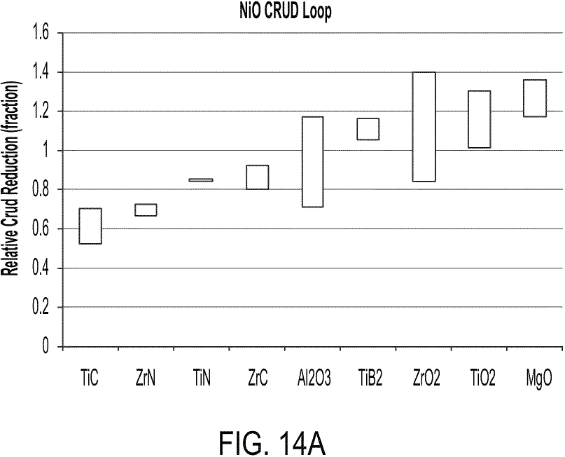

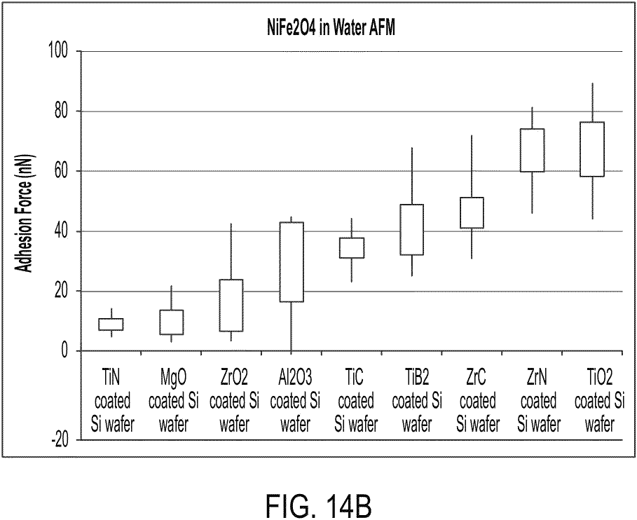

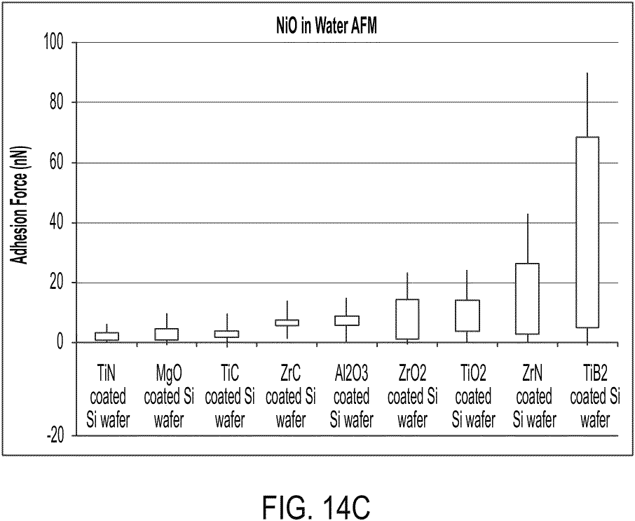

The Gen-I materials were deposited via PVD on unmasked ring samples, and the sample rings were placed in the IHTFP, which was operated without hydrogen overpressure. After one to two weeks in the IHTFP, the sample rings were removed and analyzed via SEM imaging. Relative crud reduction for each coating material is shown in FIG. 14A. From FIG. 14A, it can be seen that the coating materials were arranged in the following order, from best performance (e.g., lowest amount of crud) to worst performance (e.g., largest amount of crud): TiC, ZrN, TiN, ZrC, Al₂O₃, TiB₂, ZrO₂, TiO₂, MgO.

The flow loop results were compared with AFM measurements, which were carried out on three different instruments (Asylum MFP-3D, ezAFM AQUA, VEECO Dimension 3100). AFM measurements were conducted using probes in which the sphere and cantilever had been coated with either NiO or NiFe₂O₄ via PVD (by PVD Products Inc.).

AFM results for each of the 9 Gen-I materials are shown in FIGS. 12B and 12C. FIG. 14B shows adhesion force for each coating material using a NiFe₂O₄-coated probe in water, and FIG. 14C shows adhesion force for each coating material using a NiO-coated probe in water. It was found that NiFe₂O₄ exhibited higher adhesion overall, which was consistent with finding α-Fe₂O₃ phases in real crud particles. While there was variation between different points on a sample (e.g., as high as more than 10%) due to stray reflectance of laser light from the sample and sample motion coupled to the probe motion due to the water droplet, all of the AFM measurements led to similar conclusions regarding which materials could be considered best and worst in terms of fouling resistance.

Overall, the order of materials between AFM and the flow loop showed reasonable agreement. For both the AFM and flow loop, TiC and TiN were in the top 3 and TiO₂ was in the bottom 3. The only serious disagreements were MgO, which had good performance in the AFM and poor performance in the flow loop, and ZrN, which had poor performance in the AFM and good performance in the flow loop.

### Gen-II Coating Materials

3 Gen-II coating materials - CaF₂, SiO₂, and Na₃AlF₆ - were selected based on low vdW adhesion and Lifshitz theory. Coatings having thicknesses of 1 µm and 50 nm were deposited on sample rings and tested in the flow loop. The sample rings were subsequently removed and examined via SEM and laser scattering.

The 1-µm-thick coatings were deposited by PVD Products, Inc. and were completed without a mask, so there was not a sharp boundary between coated and uncoated sections. The CaF₂ and Na₃AlF₆ coatings exhibited an improved crud resistance, while the SiO2 coating exhibited a reduced crud resistance, compared to control surfaces.

The 50-nm-thick coatings were deposited using a custom PVD system (Lesker PRO 75) and were completed with a mask, resulting in a sharp boundary between coated and uncoated sections. At 50 nm thickness, none of the Gen-II materials showed an observable effect on crud reduction. This lack of effect was unexpected since Lifshitz theory predicts that a layer as thin as 10 nm may still diminish adhesive force, but one possible explanation is that a layer as thin as 50 nm may tend to form holes or voids where foulant particles can stick, which may allow for continued growth of crud. Even a small fraction of flaws in the coating may be sufficient for a runaway crud growth reaction since subsequent layers can stick onto already adhered crud. An increased thickness (e.g., a few hundred nanometers) may ensure that even the thinnest points on a coating have tens of nanometers covering the substrate surface.

### Gen-III Coating Materials

Gen-III coating materials - F-DLC, FTO, and amorphous carbon - were also studied in the flow loop. Prior to deposition, the ring sample surfaces were cleaned with either plasma (pls) or solvent (solv). Coatings having thicknesses of both 100 nm and 1 µm were studied for amorphous carbon.

The Gen-III materials visibly reduced crud deposition. It was observed, for example, that the 100 nm amorphous carbon coating had the same color before and after the flow loop, indicating that its crud resistance was not due to breaking-off, dissolution, or delamination, but rather due to real adhesive force decrease.

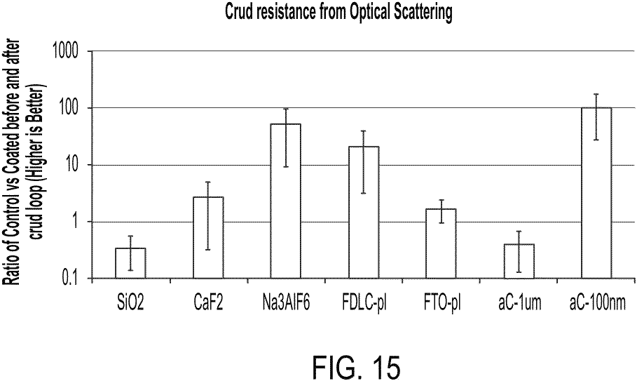

Laser scattering measurements were performed on Gen-II and Gen-III materials, and the results are shown in FIG. 15. In particular, FIG. 15 shows a crud resistance parameter Rc (i.e., the ratio of average light intensity of coated to control surfaces before and after the flow loop) for the Gen-II materials SiO₂, CaF₂, and Na₃AlF₆ and for the Gen-III materials F-DLC (plasma cleaned), FTO (plasma cleaned), 1-µm-thick amorphous carbon, and 100-nm-thick amorphous carbon. As defined, a larger Rc value indicates better anti-fouling performance. From FIG. 15, it can be seen that 100-nm-thick amorphous carbon, Na₃AlF₆, and plasma-cleaned F-DLC all exhibited significant crud reduction, with an Rc from 10 to 100. In contrast, SiO₂ and 1-µm-thick amorphous carbon performed worse than no coating, with an Rc less than 1. Possible explanations are that the SiO₂ engaged in hydrogen bonding with available oxide groups, while the 1-µm-thick amorphous carbon decomposed due to epitaxial strain and changed into more adhesive graphite forms.

### Conclusion

One conclusion from the Gen-I flow loop tests is that all coating materials containing an oxygen atom performed worse in the flow loop than expected from the AFM results, whereas those without oxygen showed similar performance. It was also noteworthy that thebest performing Gen-II and Gen-III materials had no oxygen atoms. Without wishing to be bound by a particular theory, oxygen may enable OH-mediated hydrogen bonding, which may enhance adhesive forces at high temperature conditions. For example, within the Gen-II materials, the SiO₂ coating resulted in a higher crud coverage than the CaF₂ and Na₃AlF₆ coatings - as noted above, this may be due to the oxygen atoms in SiO₂ allowing hydrogen bonding to OH groups functionalizing crud.

Overall, the flow loop tests confirmed that a number of coating materials predicted to have low adhesion - including 100-nm-thick amorphous carbon, Na₃AlF₆, and F-DLC -successfully demonstrated fouling resistance under PWR-like operating conditions.

### Example 3

In this Example, tests were conducted in the MIT reactor (MITR) flow loop to identify coating materials that could survive radiation exposure. Unlike the IHTFP, which has no radiation exposure, the MITR has a neutron spectrum similar to a PWR. In this Example, samples were tested in a radioactive environment by placing them in a flow loop integrated with the MITR.

### MIT Reactor (MITR)

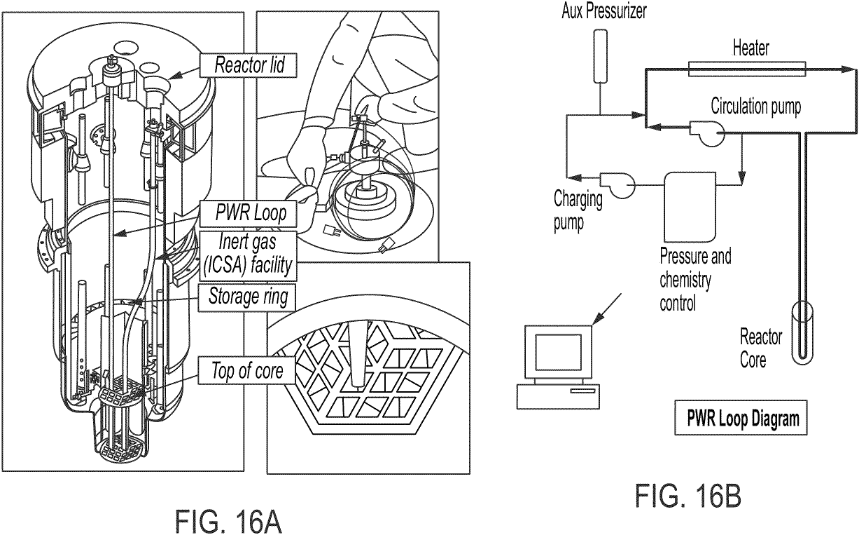

The MIT Reactor is a 5 MW research reactor with a neutron spectrum designed to closely match the spectrum of an operating PWR. Its irradiation facilities include a flow loop, a section of which enters the core and is exposed to neutron flux. There is a tube section in which water is heated and pressurized to PWR conditions, and a pump circulates water through a section containing the samples. Schematic diagrams of the MITR flow loop are shown in FIGS. 16A-16B.

The samples were placed in the MITR core for two 10-week cycles. Following radiation exposure, the samples required a cool-down period of approximately 10 weeks. The coatings were subsequently examined using Raman spectroscopy to determine the presence of specific functional groups.

### Samples

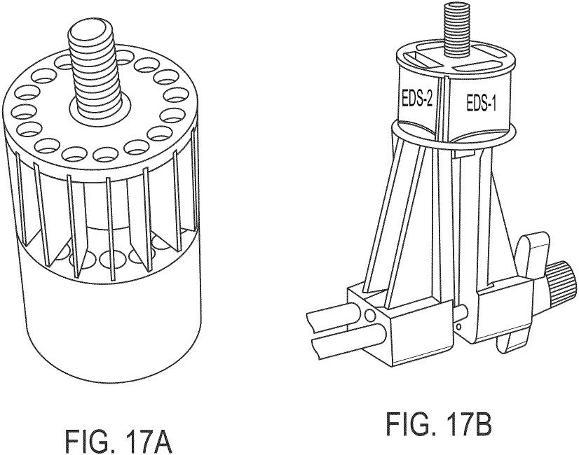

The substrates in this Example were square zirconium plates modified by sandblasting and Zn nanotube deposition. The Gen-II coatings were deposited on top of these substrates, and the coated square samples were subsequently inserted into metallic holders that exposed both sides of the samples to the flowing water stream. Photographs of the sample holder used in MITR testing for 10 × 10 mm samples (left) and 25 × 25 mm samples (right) are shown in FIGS. 17A-17B. In the MITR flow loop, water flowed through the holder, passing through holes between the samples and in contact with the samples.

### Raman Spectroscopy

Raman spectroscopy was used to study the samples after irradiation. Optical techniques like Raman spectroscopy sense the surface optically and will give the same result only if the coating maintains its optical properties throughout the experiment. It is sensitive to the chemistry of the outer surface, and it will therefore detect any changes in coating properties, as well as any removal or covering of the coating (e.g., by metal oxide growth or deposition).

### Results

Following two 10-week cycles of irradiation in the MITR, under PWR-like pressure, temperature, flow, and neutron spectrum conditions, the samples were highly radioactive at approximately 25 rem/hour. After another 6 months, the contact dose was below 80 mrem/hr, and the samples could be handled from a distance. It was observed that the sample radioactivity was largely due to particulate matter settling on it from elsewhere in the loop, since after a swab cleaning of the surface, the level of radioactivity decreased by over 50%.

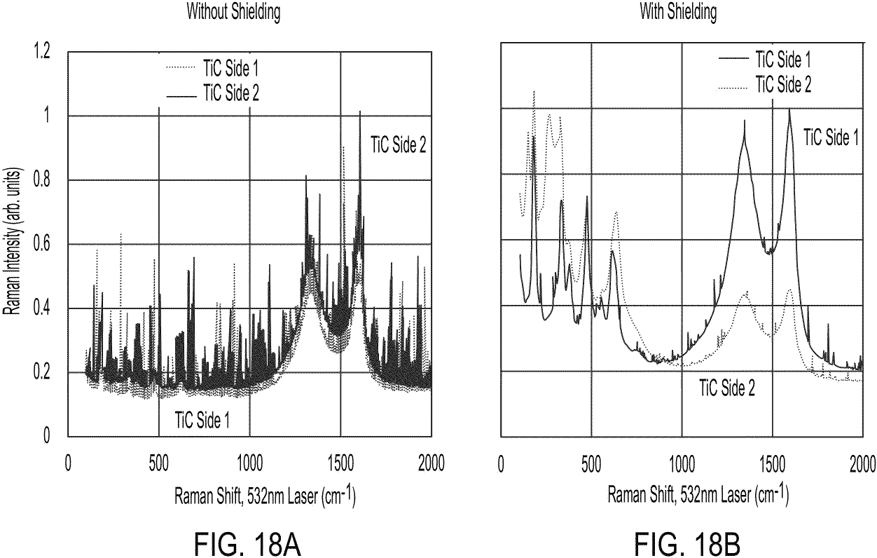

A Raman instrument (Horiba LabRAM 150) was used to study the samples. Three lead bricks were placed in front of the detector to block gamma radiation, which would otherwise have led to very high noise levels that would have overwhelmed the Raman signal. To illustrate the effect of gamma radiation, FIG. 18 shows Raman spectra of an irradiated TiC sample without shielding (left) and with lead shielding in front of the detector (right).

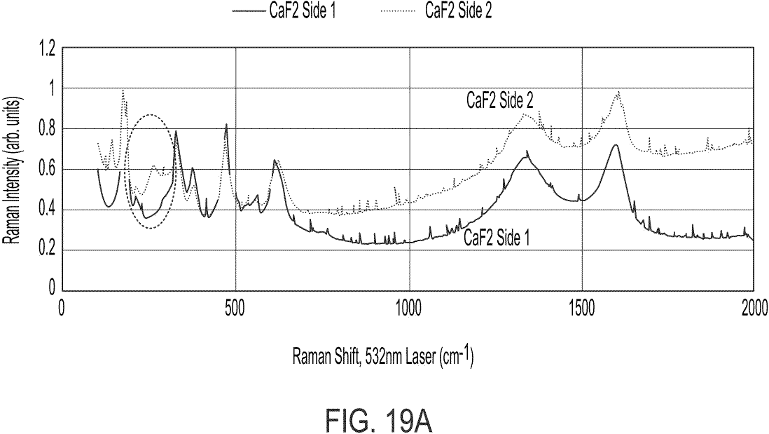

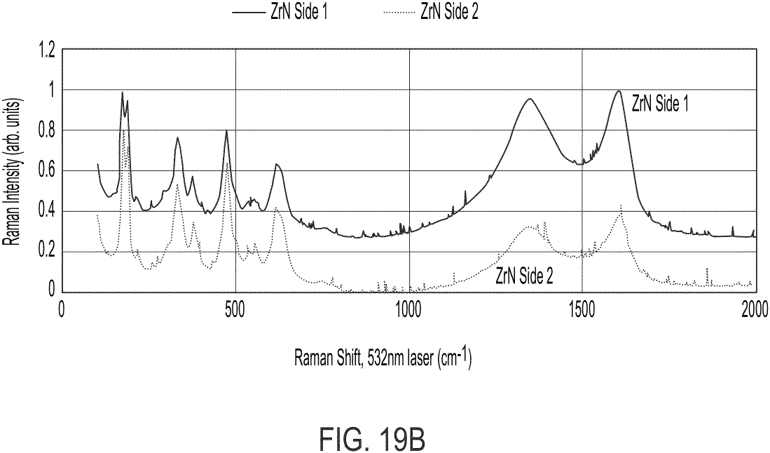

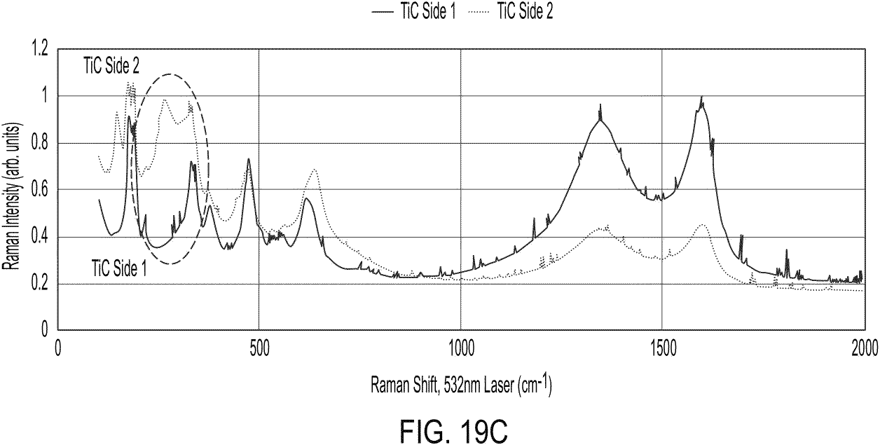

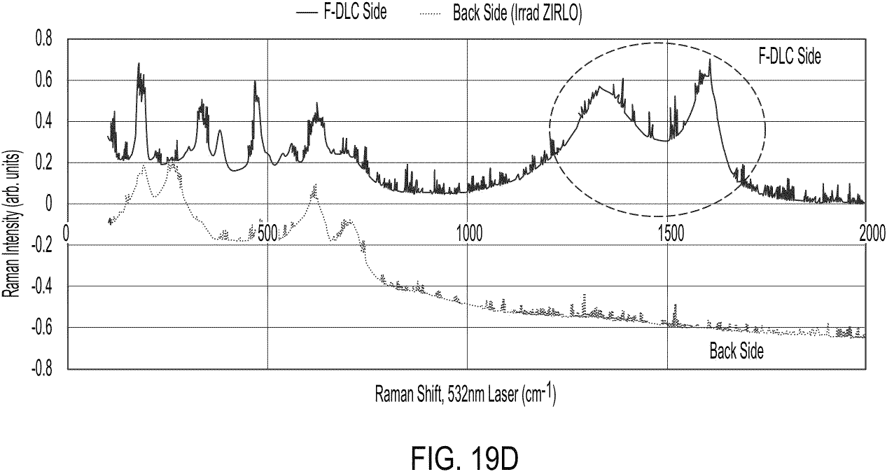

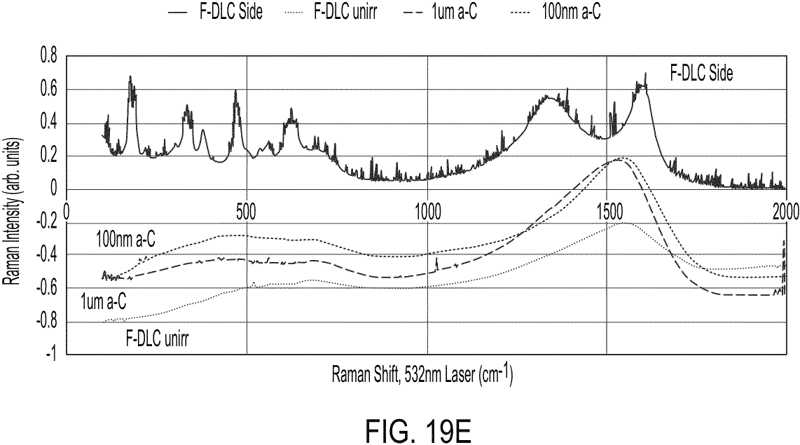

Subsequently, two sides of the samples were measured using the shielded Raman instrument, and a comparison between them established whether the coating survived irradiation. Even with the lead shielding, some gamma noise persisted, appearing in the Raman spectra as narrow spikes rising from the baseline true signal. These narrow spikes could be easily visually distinguished from the rest of the signal. In the comparison of the two sides of the samples, only broad peaks and differences in spectra were analyzed to avoid inadvertently measuring effects of gamma noise. FIGS. 19A-D show Raman spectra for both sides of the CaF₂ (FIG. 19A), ZrN (FIG. 19B), TiC (FIG. 19C), and F-DLC (FIG. 19D) coatings. FIG. 19E shows Raman spectra for irradiated and unirradiated F-DLC, unirradiated 1-µm-thick amorphous carbon, and unirradiated 100-nm-thick amorphous carbon.

The CaF₂ and ZrN samples did not show significant differences in Raman spectrum between the two sample sides; thus, it was concluded that these materials did not survive irradiation. The TiC sample showed a difference in response near 270 cm⁻¹, which matched literature data, so it was concluded that TiC survived irradiation. The F-DLC sample similarly showed a large carbon-like spectrum on the coated side that was different from the uncoated side, illustrating that the coating survived irradiation. However, comparison between pre- and post-irradiation spectra for F-DLC suggested the presence of radiation damage in the carbon layer. As shown in FIG. 19E, while the Raman spectrum for unirradiated F-DLC was similar to that for the unirradiated amorphous carbon coatings (both 1 µm thick and 100 nm thick), the irradiated F-DLC Raman spectrum exhibited some differences.

Overall, the MITR flow loop tests demonstrate that the TiC coating successfully survived irradiation under PWR-like conditions.

Various inventive concepts may be embodied as one or more processes, of which examples have been provided. The acts performed as part of each process may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

The terms “approximately,” “substantially,” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. An article, comprising:
a substrate; and
a composite coating disposed on at least a portion of the substrate, wherein the composite coating comprises a first region comprising a first material and a second region comprising a second material,
wherein the composite coating is configured to be exposed to a fluid comprising one or more foulants during use.

2. The article according to claim 1, wherein the first material is different from the second material.

3. The article according to claim 1, wherein the composite coating comprises a plurality of first regions and/or a plurality of second regions.

4. The article according to claim 3, wherein the plurality of first regions and/or the plurality of second regions are patterned according to a regular or irregular pattern.

5. The article according to claim 1, wherein the first region is a first layer and the second region is a second layer disposed on the first layer.

6. The article according to claim 5, wherein the first layer has a thickness in a range from 3 nm to 500 nm and the second layer has a thickness in a range from 3 nm to 500 nm.

7. The article according to claim 1, wherein the composite coating has a thickness in a range from 50 nm to 1 µm.

8. The article according to claim 1, wherein the first material is ITO and the second material is SiN.

9. The article according to claim 1, wherein the fluid is water.

10. An article, comprising:
a substrate; and
a composite coating disposed on at least a portion of the substrate, wherein the composite coating comprises a first region comprising a first material and a second region comprising a second material, wherein the first material is associated with a first set of optical properties over a range of wavelengths, and wherein the second material is associated with a second set of optical properties over the range of wavelengths,
wherein the composite coating is configured to be exposed to a fluid comprising one or more foulants during use, wherein the fluid is associated with a third set of optical properties over the range of wavelengths, and
wherein a mean percentage difference between the third set of optical properties and an average of the first set of optical properties and the second set of optical properties is about 20% or less.

11. The article according to claim 10, wherein the mean percentage difference is about 10% or less.

12. The article according to claim 10, wherein the range of wavelengths ranges from 10 nm to 1 µm.

13. The article according to claim 10, wherein the range of wavelengths ranges from 100 nm to 700 nm.

14. The article according to claim 10, wherein the average is a weighted average weighted by volume fraction.

15. The article according to claim 10, wherein the first set of optical properties is a first set of refractive indices, the second set of optical properties is a second set of refractive indices, and the third set of optical properties is a third set of refractive indices.

16. The article according to claim 15, wherein a root-mean-square deviation of an average of the first set of refractive indices and the second set of refractive indices from the third set of refractive indices is about 0.5 or less.

17. The article according to claim 16, wherein the root-mean-square deviation is 0.1 or less.

18. The article according to claim 16, wherein the average is a weighted average weighted by volume fraction.

19. The article according to claim 10, wherein the first set of optical properties is a first set of dielectric response values, the second set of optical properties is a second set of dielectric response values, and the third set of optical properties is a third set of dielectric response values.

20. The article according to claim 19, wherein a root-mean-square deviation of an average of the first set of dielectric response values and the second set of dielectric response values from the third set of dielectric response values is about 10 or less.

21. The article according to claim 20, wherein the root-mean-square deviation is about 5 or less.

22. A system, comprising:
an article, comprising:
a substrate; and
a composite coating disposed on at least a portion of the substrate, wherein the composite coating comprises a first region comprising a first material and a second region comprising a second material; and
a fluid comprising one or more foulants, wherein the fluid is in physical contact with the article.

23. The system according to claim 22, wherein the fluid is water.

24. A system, comprising:
an article, comprising:
a substrate; and
a composite coating disposed on at least a portion of the substrate, wherein the composite coating comprises a first region comprising a first material and a second region comprising a second material, wherein the first material is associated with a first set of optical properties over a range of wavelengths, and wherein the second material is associated with a second set of optical properties over the range of wavelengths; and
a fluid comprising one or more foulants, wherein the fluid is in physical contact with the article, and wherein the fluid is associated with a third set of optical properties over the range of wavelengths,
wherein a mean percentage difference between the third set of optical properties and an average of the first set of optical properties and the second set of optical properties is about 20% or less.

25. The system according to claim 24, wherein the fluid is water.

26. A method, comprising:
depositing a first material of a composite coating in a first region on a substrate; and
depositing a second material of the composite coating in a second region on the substrate,
wherein the composite coating is configured to be exposed to a fluid comprising one or more foulants during use, and
wherein the first material of the composite coating is associated with a first set of optical properties over a range of wavelengths, the second material of the composite coating is associated with a second set of optical properties over the range of wavelengths, and the fluid is associated with a third set of optical properties over the range of wavelengths, and wherein a mean percentage difference between the third set of optical properties and an average of the first set of optical properties and the second set of optical properties is about 20% or less.

27. The method according to claim 26, wherein the first material and/or the second material is deposited via a physical vapor deposition method.

28. The method according to claim 26, wherein the first material and/or the second material is deposited via a chemical vapor deposition method.
